(19) United States
(12) Patent Application Publication
(10) Pub. No.: US 2024/0255859 A1
(43) Pub. Date: Aug. 1, 2024

(54) ELECTROPHOTOGRAPHIC PHOTOSENSITIVE MEMBER

(71) Applicant: KYOCERA Document Solutions Inc., Osaka (JP)

(72) Inventors: Kazutaka SUGIMOTO, Osaka-shi, Osaka (JP); Ryota MORIKAWA, Osaka-shi, Osaka (JP); Hiroki OTSUKA, Osaka-shi, Osaka (JP)

(73) Assignee: KYOCERA Document Solutions Inc., Osaka (JP)

(21) Appl. No.: 18/562,364

(22) PCT Filed: Mar. 25, 2022
(86) PCT No.: PCT/JP2022/014445

§ 371 Date: Nov. 20, 2023

(30) Foreign Application Priority Data
May 26, 2021 (JP) 2021-088347

(51) Int. Cl. G03G 5/05; G03G 5/047; G03G 5/06

(52) U.S. Cl. CPC G03G 5/056; G03G 5/047; G03G 5/0672

(57) ABSTRACT

An electrophotographic photosensitive member includes a conductive substrate and a photosensitive layer. The photosensitive layer contains a charge generating material, a hole transport material, a first resin, and a second resin. The first resin is contained in the same layer as the second resin. The second resin has a percentage content of at least 1% and no greater than 3% to the total mass of the first resin and the second resin. The first resin includes repeating units represented by formulas (1), (2), (3), and (4).

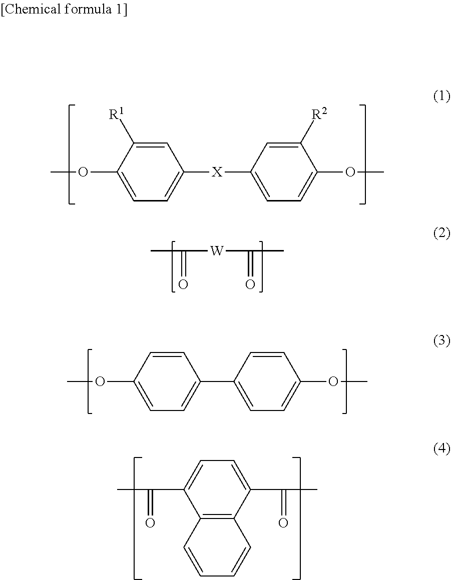

The repeating unit represented by the formula (3) has a percentage content of greater than 0% and less than 20% to the total number of repeats of the repeating units represented by the formulas (1) and (3). The second resin is a polyester resin different from the first resin.

### TECHNICAL FIELD

The present invention relates to an electrophotographic photosensitive member.

### BACKGROUND ART

Electrophotographic photosensitive members are used in electrographic image forming apparatuses (e.g., printers and multifunction peripherals) as image bearing members. An electrophotographic photosensitive member includes a photosensitive layer. Examples of the electrophotographic photosensitive member include a single-layer electrophotographic photosensitive member and a multi-layer electrophotographic photosensitive member. The single-layer electrophotographic photosensitive member includes a single-layer photosensitive layer having a charge generation function and a charge transport function. The multi-layer electrophotographic photosensitive member includes a photosensitive layer including a charge generating layer having a charge generation function and a charge transport layer having a charge transport function.

Patent Literature 1 discloses an electrophotographic photosensitive member with a surface layer containing a polyarylate resin obtained from a dihydric phenol component and a dibasic carboxylic acid component represented by the following formula.

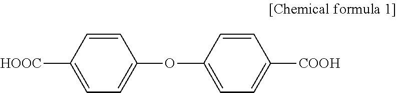 [SMILES: O=C(O)c1ccc(Oc2ccc(C(=O)O)cc2)cc1]

### CITATION LIST

### Patent Literature

### Patent Literature 1

Japanese Patent Application Laid-Open Publication No. H10-20514

### SUMMARY OF INVENTION

### Technical Problem

However, the present inventors studied to find that the electrophotographic photosensitive member disclosed in Patent Literature 1 was insufficient in abrasion resistance, inhibition of peeling of the photosensitive layer (also referred to below as film peeling), and favorable formation of a photosensitive layer through increasing solubility of a binder resin in a solvent for photosensitive layer formation.

The present invention has been made in view of the foregoing and has its object of providing an electrophotographic photosensitive member that includes a favorably formed photosensitive layer, that is excellent in abrasion resistance, and that can inhibit film peeling.

### Solution to Problem

An electrophotographic photosensitive member according to an aspect of the present invention includes a conductive substrate and a photosensitive layer. The photosensitive layer contains a charge generating material, a hole transport material, a first resin, and a second resin. The first resin is contained in a same layer as the second resin. The second resin has a percentage content of at least 1% and no greater than 3% to total mass of the first resin and the second resin. The first resin includes repeating units represented by formulas (1), (2), (3), and (4). The repeating unit represented by the formula (3) has a percentage content of greater than 0% and less than 20% to a total number of repeats of the repeating units represented by the formulas (1) and (3). The second resin is a polyester resin different from the first resin.

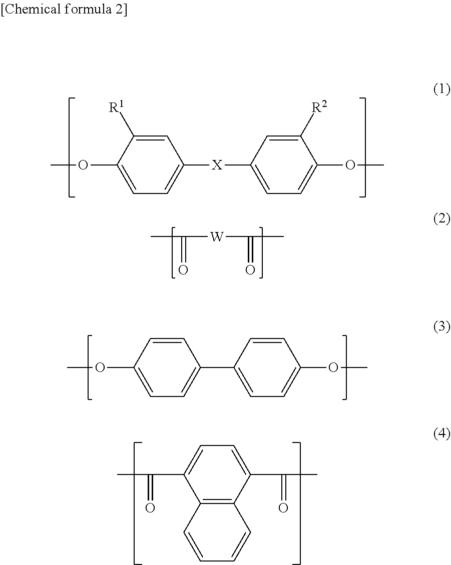

In the formula (1), R¹ and R² each represent, independently of one another, a hydrogen atom or a methyl group and X represents a divalent group represented by formula (X1) or (X2). In the formula (2), W represents a divalent group represented by formula (W1) or (W2).

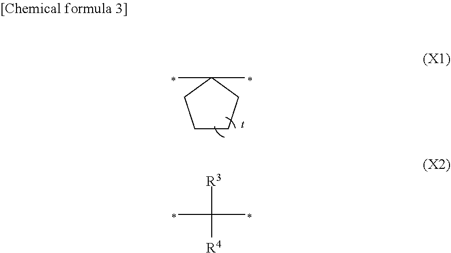

In the formula (X1), t represents an integer of at least 1 and no greater than 3 and * represents a bond. In the formula (X2), R³ and R⁴ each represent a hydrogen atom or an alkyl group with a carbon number of at least 1 and no greater than 4, R³ and R⁴ represent groups different from each other, and * represents a bond.

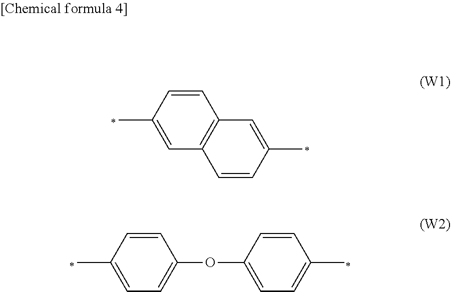

In the formulas (W1) and (W2), * represents a bond.

### Advantageous Effects of Invention

The electrophotographic photosensitive member of the present invention includes a favorably formed photosensitive layer, is excellent in abrasion resistance, and can inhibit film peeling.

### BRIEF DESCRIPTION OF DRAWINGS

FIG. 1 is a partial cross-sectional view of a multi-layer electrophotographic photosensitive member that is an example of an electrophotographic photosensitive member according to an embodiment of the present invention.

FIG. 2 is a partial cross-sectional view of a multi-layer electrophotographic photosensitive member that is an example of the electrophotographic photosensitive member according to an embodiment of the present invention.

FIG. 3 is a partial cross-sectional view of a multi-layer electrophotographic photosensitive member that is an example of the electrophotographic photosensitive member according to an embodiment of the present invention.

FIG. 4 is a partial cross-sectional view of a single-layer electrophotographic photosensitive member that is an example of the electrophotographic photosensitive member according to an embodiment of the present invention.

FIG. 5 is a partial cross-sectional view of a single-layer electrophotographic photosensitive member that is an example of the electrophotographic photosensitive member according to an embodiment of the present invention.

FIG. 6 is a partial cross-sectional view of a single-layer electrophotographic photosensitive member that is an example of the electrophotographic photosensitive member according to an embodiment of the present invention.

FIG. 7 is a ¹H-NMR spectrum of a resin (1-H).

### DESCRIPTION OF EMBODIMENTS

The following describes embodiments of the present invention in detail. However, the present invention is not limited to the following embodiments and can be practiced with alteration within a scope of the object of the present invention. Note that the gist of the present invention is not limited although descriptions may be omitted as appropriate where descriptions are redundant. In the following description, the term “-based” may be appended to the name of a chemical compound to form a generic name encompassing both the chemical compound itself and derivatives thereof. Also, when the term “-based” is appended to the name of a chemical compound used in the name of a polymer, the term indicates that a repeating unit of the polymer originates from the chemical compound or a derivative thereof. “General formula” and “chemical formula” are each commonly referred to as “formula”. The phrase “each represent, independently of one another,” in description about formulas means possibly representing the same group or different groups. One type of each component described in the present specification may be used independently, or two or more types of the component may be used in combination unless otherwise stated. Values for glass transition point (Tg) are values as measured in accordance with “the Japanese Industrial Standards (JIS) K7121-2012” using a differential scanning calorimeter (“DSC-6220”, product of Seiko Instruments Inc.) unless otherwise stated. The glass transition point corresponds to the temperature corresponding to a point of inflection (specifically, an intersection point of an extrapolated baseline and an extrapolated falling line) caused by glass transition on a heat absorption curve (vertical axis: heat flow (DSC signal), horizontal axis: temperature) plotted using the differential scanning calorimeter. Measurement values for number average molecular weight (Mn) are values as measured using gel permeation chromatography unless otherwise stated. Measurement values for acid value and hydroxyl value are values as measured in accordance with “the Japanese Industrial Standards (JIS) K0070-1992” unless otherwise stated.

Substituents used in the present specification are described next. Examples of a halogen atom (halogen group) include a fluorine atom (fluoro group), a chlorine atom (chloro group), a bromine atom (bromo group), and an iodine atom (iodine group).

Examples of an alkyl group with a carbon number of at least 1 and no greater than 8, an alkyl group with a carbon number of at least 1 and no greater than 6, an alkyl group with a carbon number of at least 1 and no greater than 4, an alkyl group with a carbon number of at least 1 and no greater than 3, and an alkyl group with a carbon number of 3 each are an unsubstituted straight chain or branched chain alkyl group. Examples of the alkyl group with a carbon number of at least 1 and no greater than 8 include a methyl group, an ethyl group, an n-propyl group, an isopropyl group, an n-butyl group, a sec-butyl group, a tert-butyl group, an n-pentyl group, a 1-methylbutyl group, a 2-methylbutyl group, a 3-methylbutyl group, a 1-ethylpropyl group, a 2-ethylpropyl group, a 1,1-dimethylpropyl group, a 1,2-dimethylpropyl group, a 2,2-dimethylpropyl group, an n-hexyl group, a 1-methylpentyl group, a 2-methylpentyl group, a 3-methylpentyl group, a 4-methylpentyl group, a 1,1-dimethylbutyl group, a 1,2-dimethylbutyl group, a 1,3-dimetylbutyl group, a 2,2-dimethylbutyl group, a 2,3-dimethylbutyl group, a 3,3-dimethylbutyl group, a 1,1,2-trimethylpropyl group, a 1,2,2-trimethylpropyl group, a 1-ethylbutyl group, a 2-ethylbutyl group, a 3-ethylbutyl group, a straight chain or branched chain heptyl group, and a straight chain or branched chain octyl group. Examples of the alkyl group with a carbon number of at least 1 and no greater than 6, the alkyl group with a carbon number of at least 1 and no greater than 4, the alkyl group with a carbon number of at least 1 and no greater than 3, and the alkyl group with a carbon number of 3 include groups each with a corresponding carbon number among those listed as the examples of the alkyl group with a carbon number of at least 1 and no greater than 8.

A perfluoroalkyl group with a carbon number of at least 1 and no greater than 10, a perfluoroalkyl group with a carbon number of at least 3 and no greater than 10, a perfluoroalkyl group with a carbon number of at least 5 and no greater than 7, and a perfluoroalkyl group with a carbon number of 6 each are an unsubstituted straight chain or branched chain perfluoroalkyl group unless otherwise stated. Examples of the perfluoroalkyl group with a carbon number of at least 1 and no greater than 10 include a trifluoromethyl group, a perfluoroethyl group, a perfluoro-n-propyl group, a perfluoroisopropyl group, a perfluoro-n-butyl group, a perfloro-sec-butyl group, a perfluoro-tert-butyl group, a perfluoro-n-pentyl group, a perfluoro-1-methylbutyl group, a perfluoro-2-methylbutyl group, a perfluoro-3-methylbutyl group, a perfluoro-1-ethylpropyl group, a perfluoro-2-ethylpropyl group, a perfluoro-1,1-dimethylpropyl group, a perfluoro-1,2-dimethylpropyl group, a perfluoro-2,2-dimethylpropyl group, a perfluoro-n-hexyl group, a perfluoro-1-methylpentyl group, a perfluoro-2-methylpentyl group, a perfluoro-3-methylpentyl group, a perfluoro-4-methylpentyl group, a perfluoro-1,1-dimethylbutyl group, a perfluoro-1,2-dimetylbutyl group, a perfluoro-1,3-dimethylbutyl group, a perfluoro-2,2-dimethylbutyl group, a perfluoro-2,3-dimethylbutyl group, a perfluoro-3,3-dimethylbutyl group, a perfluoro-1,1,2-trimethylpropyl group, a perfluoro-1,2,2-trimethylpropyl group, a perfluoro-1-ethylbutyl group, a perfluoro-2-ethylbutyl group, a perfluoro-3-ethylbutyl group, a straight chain or branched chain perfluoroheptyl group, a straight chain or branched chain perfluorooctyl group, a straight chain or branched chain perfluorononyl group, and a straight chain or branched chain perfluorodecyl group.

Examples of the perfluoroalkyl group with a carbon number of at least 3 and no greater than 10, the perfluoroalkyl group with a carbon number of at least 5 and no greater than 7, and the perfluoroalkyl group with a carbon number of 6 include groups each with a corresponding carbon number among the groups listed as the examples of the perfluoroalkyl group with a carbon number of at least 1 and no greater than 10.

An alkanediyl group with a carbon number of at least 1 and no greater than 6 and an alkanediyl group with a carbon number of at least 1 and no greater than 3 each are an unsubstituted straight chain or branched chain alkanediyl group unless otherwise stated. Examples of the alkanediyl group with a carbon number of at least 1 and no greater than 6 include a methanediyl group (methylene group), an ethanediyl group, an n-propanediyl group, an isopropanediyl group, an n-butanediyl group, a sec-butanediyl group, a tert-butanediyl group, an n-pentanediyl group, a 1-methylbutanediyl group, a 2-methylbutanediyl group, a 3-methylbutanediyl group, a 1-ethylpropanediyl group, a 2-ethylpropanediyl group, a 1,1-dimethylpropanediyl group, a 1,2-dimethylpropanediyl group, a 2,2-dimethylpropanediyl group, an n-hexanediyl group, a 1-methylpentanediyl group, a 2-methylpentanediyl group, a 3-methylpentanediyl group, a 4-methylpentanediyl group, a 1,1-dimethylbutanediyl group, a 1,2-dimethylbutanediyl group, a 1,3-dimethylbutanediyl group, a 2,2-dimethylbutanediyl group, a 2,3-dimethylbutanediyl group, a 3,3-dimethylbutanediyl group, a 1,1,2-trimethylpropanediyl group, a 1,2,2-tirmehylpropanediyl group, a 1-ethylbutanediyl group, a 2-ethylbutanediyl group, and a 3-ethylbutanediyl group. Examples of the alkanediyl group with a carbon number of at least 1 and no greater than 3 include groups each with a corresponding carbon number listed as the examples of the alkanediyl group with a carbon number of at least 1 and no greater than 6. The substituents used in the present specification have been described so far.

### [Electrophotographic Photosensitive Member]

Embodiments of the present invention relates to an electrophotographic photosensitive member (also referred to below as photosensitive member). The photosensitive member of the present embodiment includes a conductive substrate and a photosensitive layer. Preferably, the photosensitive layer is provided as an outermost surface layer of the photosensitive member. The photosensitive layer contains a charge generating material, a hole transport material, a first resin, and a second resin. In order to increase abrasion resistance and inhibit film peeling, the outermost surface layer of the photosensitive member preferably contains at least the first resin and the second resin.

For example, the photosensitive member may be a single-layer electrophotographic photosensitive member (also referred to below as single-layer photosensitive member) or a multi-layer electrophotographic photosensitive member (also referred to below as multi-layer photosensitive member).

### <Multi-layer Photosensitive Member>

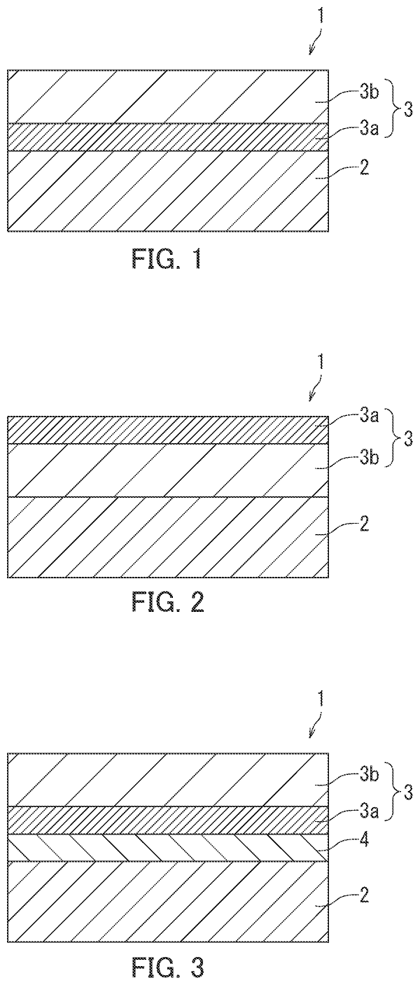

With reference to FIGS. 1 to 3, a multi-layer photosensitive member 1 that is an example of the photosensitive member is described below. FIGS. 1 to 3 each are a partial cross-sectional view of the multi-layer photosensitive member 1.

As illustrated in FIG. 1, the multi-layer photosensitive member 1 includes a conductive substrate 2 and a photosensitive layer 3, for example. The photosensitive layer 3 includes a charge generating layer 3a and a charge transport layer 3b. That is, the multi-layer photosensitive member 1 includes a charge generating layer 3a and a charge transport layer 3b as the photosensitive layer 3. The charge generating layer 3a is a single layer, for example. The charge transport layer 3b is a single layer, for example.

As illustrated in FIG. 1, it is possible that the charge generating layer 3a is provided on the conductive substrate 2 and the charge transport layer 3b is provided on the charge generating layer 3a. Alternatively, it is possible that the charge transport layer 3b is provided on the conductive substrate 2 and the charge generating layer 3a is provided on the charge transport layer 3b as illustrated in FIG. 2.

As illustrated in FIG. 3, the multi-layer photosensitive member 1 may further include an intermediate layer 4 (undercoat layer) in addition to the conductive substrate 2 and the photosensitive layer 3. The intermediate layer 4 is provided between the conductive substrate 2 and the photosensitive layer 3. As illustrated in FIGS. 1 and 2, the photosensitive layer 3 may be provided directly on the conductive substrate 2 in the multi-layer photosensitive member 1. Alternatively, the photosensitive layer 3 may be provided on the conductive substrate 2 with the intermediate layer 4 therebetween as illustrated in FIG. 3. When the multi-layer photosensitive member 1 includes the intermediate layer 4, it is possible that the intermediate layer 4 is provided on the conductive substrate 2, the charge generating layer 3a is provided on the intermediate layer 4, and the charge transport layer 3b is provided on the charge generating layer 3a as illustrated in FIG. 3. Alternatively, it is possible that the intermediate layer 4 is provided on the conductive substrate 2, the charge transport layer 3b is provided on the intermediate layer 4, and the charge generating layer 3a is provided on the charge transport layer 3b.

The multi-layer photosensitive member 1 may further include a protective layer 5 (see FIG. 6) in addition to the conductive substrate 2 and the photosensitive layer 3. The protective layer 5 is provided on the photosensitive layer 3. As illustrated in FIGS. 1 to 3, the photosensitive layer 3 (e.g., the charge transport layer 3b or the charge generating layer 3a) may be provided as an outermost surface layer of the multi-layer photosensitive member 1. Alternatively, the protective layer 5 may be provided as the outermost surface layer of the multi-layer photosensitive member 1.

As illustrated in FIG. 1, the photosensitive layer 3 (preferably, the charge transport layer 3b) is preferably provided as the outermost surface layer of the multi-layer photosensitive member 1. It is further preferable that the charge transport layer 3b is a single layer provided as the outermost surface layer of the multi-layer photosensitive member 1. As a result of the charge transport layer 3b, which contains the first resin and the second resin, being provided as the outermost surface layer, abrasion resistance of the multi-layer photosensitive member 1 further increases and film peeling is further inhibited.

The charge generating layer 3a contains a charge generating material. The charge generating layer 3a may contain a base resin as necessary. The charge generating layer 3a may contain an additive as necessary. The thickness of the charge generating layer 3a is not limited particularly and is preferably at least 0.01 μm and no greater than 5 μm, and more preferably at least 0.1 μm and no greater than 3 μm.

The charge transport layer 3b contains a hole transport material, the first resin, and the second resin. The charge transport layer 3b may contain an additive as necessary. The thickness of the charge transport layer 3b is not limited particularly and is preferably at least 2 μm and no greater than 100 μm, and more preferably at least 5 μm and no greater than 50 μm. The multi-layer photosensitive member 1 has been described so far with reference to FIGS. 1 to 3.

### <Single-Layer Photosensitive Member>

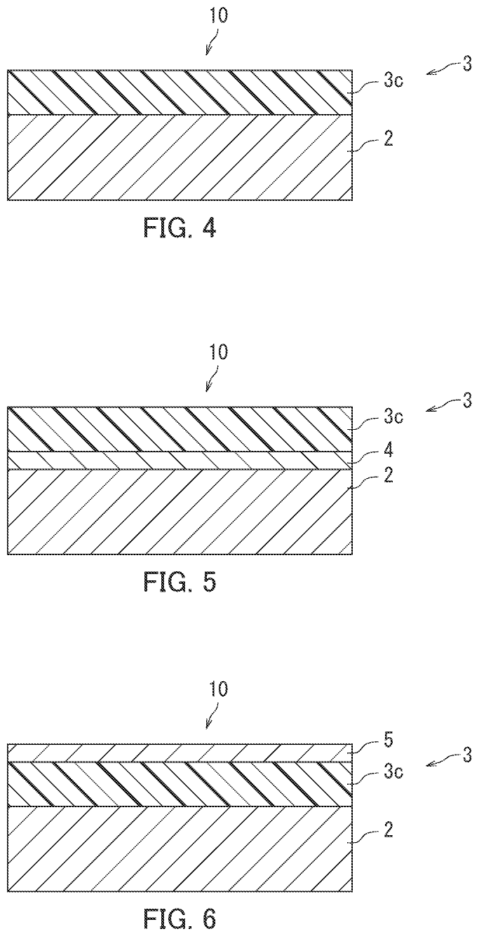

With reference to FIGS. 4 to 6, a single-layer photosensitive member 10 that is an example of the photosensitive member is described below. FIGS. 4 to 6 each are a partial cross-sectional view of the single-layer photosensitive member 10.

As illustrated in FIG. 4, the single-layer photosensitive member 10 includes a conductive substrate 2 and a photosensitive layer 3, for example. The photosensitive layer 3 included in the single-layer photosensitive member 10 is a single layer. In the following, the “photosensitive layer 3 of single layer” may be also referred to below as “single-layer photosensitive layer 3c”.

As illustrated in FIG. 5, the single-layer photosensitive member 10 may further include an intermediate layer 4 (undercoat layer) in addition to the conductive substrate 2 and the single-layer photosensitive layer 3c. The intermediate layer 4 is provided between the conductive substrate 2 and the single-layer photosensitive layer 3c. As illustrated in FIG. 4, the single-layer photosensitive layer 3c may be provided directly on the conductive substrate 2. Alternatively, the single-layer photosensitive layer 3c may be provided on the conductive substrate 2 with the intermediate layer 4 therebetween as illustrated in FIG. 5.

As illustrated in FIG. 6, the single-layer photosensitive member 10 may further include a protective layer 5 in addition to the conductive substrate 2 and the single-layer photosensitive layer 3c. The protective layer 5 is provided on the single-layer photosensitive layer 3c. As illustrated in FIGS. 4 and 5, the single-layer photosensitive layer 3c may be provided as an outermost surface layer of the single-layer photosensitive member 10. Alternatively, the protective layer 5 may be provided as the outermost surface layer of the single-layer photosensitive member 10 as illustrated in FIG. 6.

As illustrated in FIGS. 4 and 5, the photosensitive layer 3 (more specifically, the single-layer photosensitive layer 3c) is preferably provided as the outermost surface layer of the single-layer photosensitive member 10. As a result of the single-layer photosensitive layer 3c, which contains the first resin and the second resin, being provided as the outermost surface layer, abrasion resistance of the single-layer photosensitive member 10 further increases and film peeling is further inhibited.

The single-layer photosensitive layer 3c contains a charge generating material, a hole transport material, the first resin, and the second resin. The single-layer photosensitive layer 3c may further contain an electron transport material as necessary. The single-layer photosensitive layer 3c may contain an additive as necessary.

The thickness of the single-layer photosensitive layer 3c is not limited particularly and is preferably at least 5 μm and no greater than 100 μm, and more preferably at least 10 μm and no greater than 50 μm. The single-layer photosensitive member 10 has been described so far with reference to FIGS. 4 to 6.

### <First Resin>

The first resin is contained in the photosensitive layer as a binder resin, for example. The first resin is a polyarylate resin. The first resin includes repeating units represented by formulas (1), (2), (3), and (4). The repeating unit represented by the formula (3) has a percentage content of greater than 0% and less than 20% to a total number of repeats of the repeating units represented by the formulas (1) and (3).

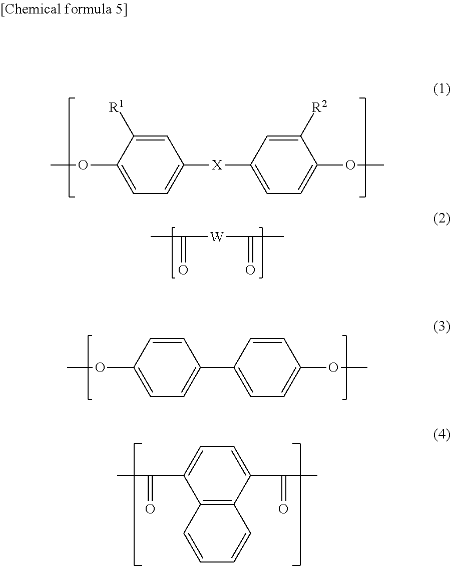

In formula (1), R¹ and R² each represent, independently of one another, a hydrogen atom or a methyl group and X represents a divalent group represented by formula (X1) or (X2). In formula (2), W represents a divalent group represented by formula (W1) or (W2).

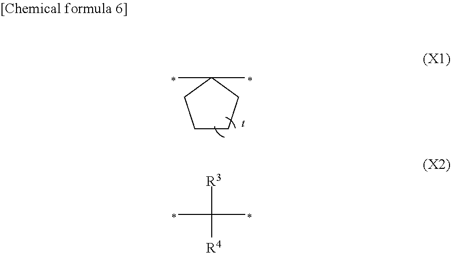

In formula (X1), t represents an integer of at least 1 and no greater than 3 and * represents a bond. In formula (X2), R³ and R⁴ each represent a hydrogen atom or an alkyl group with a carbon number of at least 1 and no greater than 4, R³ and R⁴ represent groups different from each other, and * represents a bond.

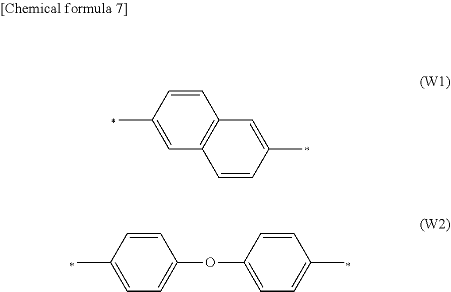

In formulas (W1) and (W2), * represents a bond.

In the following, the repeating units represented by formulas (1), (2), (3), and (4) may be also referred to below as “repeating units (1), (2), (3), and (4)”, respectively. Also, the percentage content of the repeating unit (3) to the total number of repeats of the repeating units (1) and (3) may be also referred to below as “percentage content (3)”. A resin including the repeating units (1), (2), (3), and (4) with a percentage content (3) of greater than 0% and less than 20% may be referred to as “resin (PA)”.

The resin (PA) has excellent solubility in solvents for photosensitive layer formation. As a result of use of the resin (PA) excellent in solubility as the first resin, the photosensitive layer of the photosensitive member can be formed favorably. As a result of the resin (PA) being contained as the first resin, abrasion resistance of the photosensitive member increases.

The percentage content (3) is a percentage (e.g., 100×N₃/(N₁+N₃)) of a number N₃ of repeats of the repeating unit (3) to the total of a number N₁ of repeats of the repeating unit (1) and the number N₃ of repeats of the repeating unit (3) in the resin (PA). As a result of the percentage content (3) being set to less than 20%, solubility of the resin (PA) in solvents increases. As a result of the percentage content (3) being set to greater than 0%, that is, as a result of the percentage content (3) being not 0%, abrasion resistance of a photosensitive member including a photosensitive layer containing the resin (PA) increases. The percentage content (3) is preferably at least 1%, and more preferably at least 5%. The percentage content (3) is preferably no greater than 19%, and more preferably no greater than 10%.

The repeating unit (4) has a percentage content of greater than 0% and less than 100% to the total number of repeats of the repeating units (2) and (4). The percentage content of the repeating unit (4) to the total number of repeats of the repeating units (2) and (4) may be also referred to below as “percentage content (4)”. The percentage content (4) is a percentage (e.g., 100×N₄/(N₂+N₄)) of a number N₄ of repeats of the repeating unit (4) to the total of a number N₂ of repeats of the repeating unit (2) and the number N₄ of repeats of the repeating unit (4) in the resin (PA). The percentage content (4) is greater than 0%. That is, the percentage content (4) is not 0%. As such, the resin (PA) includes the repeating unit (4). As a result of inclusion of the repeating unit (4), solubility of the resin (PA) in solvents increases and abrasion resistance of a photosensitive member including a photosensitive layer containing the resin (PA) increases. By contrast, the percentage content (4) is less than 100%. That is, the percentage content (4) is not 100%. As such, the resin (PA) includes the repeating unit (2). As a result of inclusion of the repeating unit (2), abrasion resistance of a photosensitive member including a photosensitive layer containing the resin (PA) increases. The percentage content (4) is preferably at least 1%, more preferably at least 10%, and further preferably at least 35%. The percentage content (4) is preferably no greater than 99%, more preferably no greater than 80%, and further preferably no greater than 65%.

The percentage contents (3) and (4) can be calculated from a ratio of a peak unique to each repeating unit on a ¹H-NMR spectrum of the resin (PA) plotted using a proton nuclear magnetic resonance spectrometer.

Preferably, R¹ and R² in formula (1) each represent a methyl group.

Preferably, t in formula (X1) represents 2.

It is preferable in formula (X2) that: R³ represents a hydrogen atom and R⁴ represents a methyl group, an ethyl group, or an alkyl group with a carbon number 3; R³ represents a methyl group and R⁴ represents an ethyl group or an alkyl group with a carbon number of 3; or R³ represents an ethyl group and R⁴ represents an alkyl group with a carbon number of 3. More preferably, R³ represents a methyl group and R⁴ represents an ethyl group.

The bond represented by * in formulas (X1) and (X2) is bonded to a carbon atom to which X in formula (1) is bonded. The bond represented by * in formulas (W1) and (W2) is bonded to a carbon atom to which W in formula (2) is bonded.

Examples of the repeating unit (1) include repeating units represented by formulas (1-1), (1-2), and (1-3) (also referred to below as repeating units (1-1), (1-2), and (1-3), respectively).

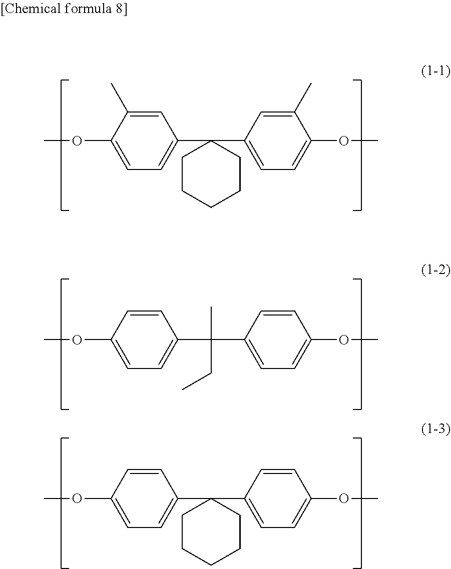

The repeating unit (2) is a repeating unit represented by formula (2-1) or (2-2) (also referred to below as repeating units (2-1) and (2-2), respectively).

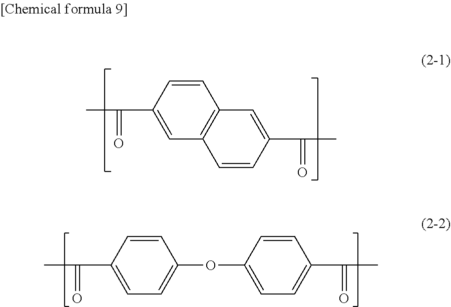

In one embodiment, it is preferable in formula (1) that R¹ and R² each represent a methyl group and X represents a divalent group represented by formula (X1). The repeating unit (1) is more preferably the repeating unit (1-1). It is further preferable that: the repeating unit (1) is the repeating unit (1-1) and the repeating unit (2) is the repeating unit (2-1); or the repeating unit (1) is the repeating unit (1-1) and the repeating unit (2) is the repeating unit (2-2).

In another embodiment, it is preferable in formula (1) that R¹ and R² each represent a hydrogen atom and X represents a divalent group represented by formula (X2). It is more preferable that the repeating unit (1) is the repeating unit (1-2). It is further preferable that: the repeating unit (1) is the repeating unit (1-2) and the repeating unit (2) is the repeating unit (2-1); or the repeating unit (1) is the repeating unit (1-2) and the repeating unit (2) is the repeating unit (2-2). When the resin (PA) described in the another embodiment is contained in the photosensitive layer, abrasion resistance of the photosensitive member further increases.

The resin (PA) may have an end group. Examples of the end group of the resin (PA) include end groups represented by formulas (T-1) and (T-2). The end group represented by formula (T-1) is preferably an end group represented by formula (T-DMP) (also referred to below as end group (T-DMP)). The end group represented by formula (T-2) is preferably an end group represented by formula (T-PFH) (also referred to below as end group (T-PFH)).

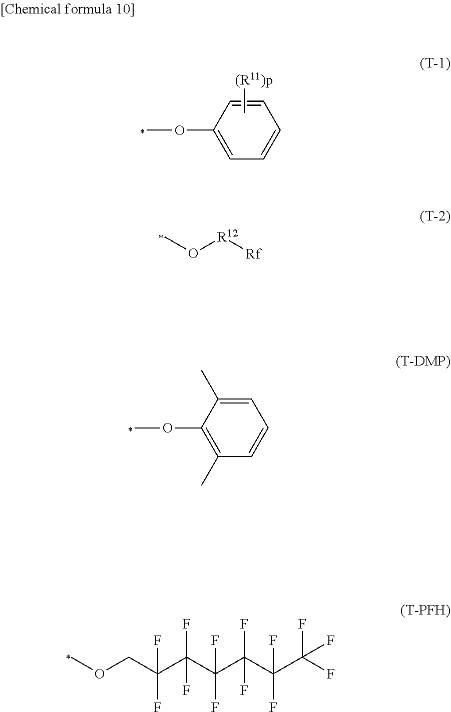

In formula (T-1), R¹¹ represents a halogen atom or an alkyl group with a carbon number of at least 1 and no greater than 6 and p represents an integer of at least 0 and no greater than 5. R¹¹ preferably represents an alkyl group with a carbon number of at least 1 and no greater than 6, more preferably represents an alkyl group with a carbon number of at least 1 and no greater than 3, and further preferably represents a methyl group. p preferably represents an integer of at least 1 and no greater than 3, and more preferably represents 2.

In formula (T-2), R¹² represents an alkanediyl group with a carbon number of at least 1 and no greater than 6 and Rf represents a perfluoroalkyl group with a carbon number of at least 1 and no greater than 10. R¹² preferably represents an alkanediyl group with a carbon number of at least 1 and no greater than 3, and more preferably represents a methylene group. Rf preferably represents a perfluoroalkyl group with a carbon number of at least 3 and no greater than 10, more preferably represents a perfluoroalkyl group with a carbon number of at least 5 and no greater than 7, and further preferably represents a perfluoroalkyl group with a carbon number of 6.

In formulas (T-1), (T-2), (T-DMP), and (T-PFH), * represents a bond. Each bond represented by * in formulas (T-1), (T-2), (T-DMP), and (T-PFH) is bonded to a repeating unit (specifically, the repeating unit (2) or (4)) derived from dicarboxylic acid located at the terminal of the resin (PA).

In order to further increase abrasion resistance of the photosensitive member, the resin (PA) being the first resin preferably has an end group having a halogen atom. For the same purpose as above, it is further preferable in formula (1) that R¹ and R² each represents a methyl group, X represents a divalent group represented by formula (X1), and the resin (PA) has an end group having a halogen atom.

An example of the end group having a halogen atom is the end group (T-1) where R¹¹ in formula (T-1) represents a halogen atom. Another example of the end group having a halogen atom is the end group (T-2).

Preferable examples of the resin (PA) include resins (PA-1) to (PA-4) shown in Table 1. The resins (PA-1) to (PA-4) each include repeating units shown in Table 1 as the repeating units (1) to (4). Units (1) to (4) in Table 1 and Table 2 described later mean the repeating units (1) to (4), respectively.

TABLE 1

| Resin | Unit (1) | Unit (2) | Unit (3) | Unit (4) |
|---|---|---|---|---|
| PA-1 | 1-1 | 2-1 | 3 | 4 |
| PA-2 | 1-2 | 2-1 | 3 | 4 |
| PA-3 | 1-1 | 2-2 | 3 | 4 |
| PA-4 | 1-2 | 2-2 | 3 | 4 |

Further preferable examples of the resin (PA) include resins (PA-a) to (PA-h) shown in Table 2. The resins (PA-a) to (PA-h) each include repeating units shown in Table 2 as the repeating units (1) to (4) and an end group shown in Table 2.

TABLE 2

| Resin | Unit (1) | Unit (2) | Unit (3) | Unit (4) | End group |
|---|---|---|---|---|---|
| PA-a | 1-1 | 2-1 | 3 | 4 | T-DMP |
| PA-b | 1-2 | 2-1 | 3 | 4 | T-DMP |
| PA-c | 1-1 | 2-2 | 3 | 4 | T-DMP |
| PA-d | 1-2 | 2-2 | 3 | 4 | T-DMP |
| PA-e | 1-1 | 2-1 | 3 | 4 | T-PFH |
| PA-f | 1-2 | 2-1 | 3 | 4 | T-PFH |
| PA-g | 1-1 | 2-2 | 3 | 4 | T-PFH |
| PA-h | 1-2 | 2-2 | 3 | 4 | T-PFH |

In the resin (PA), a repeating unit (specifically, the repeating unit (1) or (3)) derived from bisphenol and a repeating unit (specifically, the repeating unit (2) or (4)) derived from dicarboxylic acid are adjacent and bonded to each other. That is, the repeating unit (1) may be bonded to the repeating unit (2) or bonded to the repeating unit (4). Furthermore, the repeating unit (3) may be bonded to the repeating unit (2) or bonded to the repeating unit (4). The number of repeats of the repeating units derived from bisphenol is substantially equal to the number of repeats of the repeating units derived from dicarboxylic acid and satisfies a calculation formula “(Number of repeats of repeating units derived from dicarboxylic acid)=(number of repeats of repeating units derived from bisphenol)+1”. The resin (PA) may be a random copolymer, an alternating copolymer, a periodic copolymer, or a block copolymer, for example.

The resin (PA) may include one repeating unit (1) as the repeating unit (1) or may include two or more (e.g., two) repeating units (1). The resin (PA) may include one repeating unit (2) as the repeating unit (2) or may include two or more (e.g., two) repeating units (2).

The resin (PA) may further include a repeating unit other than the repeating units (1) to (4) as a repeating unit. However, the percentage content of the repeating units (1) to (4) in the total number of repeats of the repeating units in the resin (PA) is preferably at least 90%, more preferably at least 95%, further preferably at least 99%, and particularly preferably 100% in order to increase solubility in solvents and increase abrasion resistance of the photosensitive member where the photosensitive member includes a photosensitive layer containing such a resin (PA). That is, the resin (PA) particularly preferably includes only the repeating units (1) to (4) as the repeating units.

In order to increase solubility in solvents, the percentage content of the repeating unit (3) in the total number of repeats of the repeating units derived from bisphenol in the resin (PA) is preferably no greater than 20%, and more preferably less than 20%.

The first resin may be only one type of the resin (PA) or two or more types of the resin (PA).

The viscosity average molecular weight of the resin (PA) is preferably at least 10,000, more preferably at least 30,000, further preferably at least 50,000, and particularly preferably at least 55,000. As a result of the viscosity average molecular weight of the resin (PA) being at least 10,000, abrasion resistance of the photosensitive member increases where the photosensitive member includes a photosensitive layer containing such a resin (PA). By contrast, the viscosity average molecular weight of the resin (PA) is preferably no greater than 80,000, more preferably no greater than 70,000, and further preferably no greater than 60,000. As a result of the viscosity average molecular weight of the resin (PA) being no greater than 80,000, solubility of the resin (PA) in solvents increases. The viscosity average molecular weight of the resin (PA) is measured in accordance with the Japanese Industrial Standards (JIS) K7252-1:2016.

A method for producing the resin (PA) is described next. One example of the method for producing the resin (PA) is condensation polymerization of bisphenol for constituting the repeating units derived from bisphenol and dicarboxylic acid for constituting the repeating units derived from dicarboxylic acid. Any known synthesis (e.g., solution polymerization, melt polymerization, or interface polymerization) can be employed as the condensation polymerization.

Examples of the bisphenol for constituting the repeating units derived from bisphenol include compounds represented by formulas (BP-1) and (BP-3) (also referred to below as compounds (BP-1) and (BP-3), respectively). Examples of the dicarboxylic acid for constituting the repeating units derived from dicarboxylic acid include compounds represented by formulas (DC-2) and (DC-4) (also referred to below as compounds (DC-2) and (DC-4), respectively). In formulas (BP-1), R¹, R², and X are the same as defined for R¹, R², and X in formula (1), respectively. W in formula (DC-2) is the same as defined for W in formula (2).

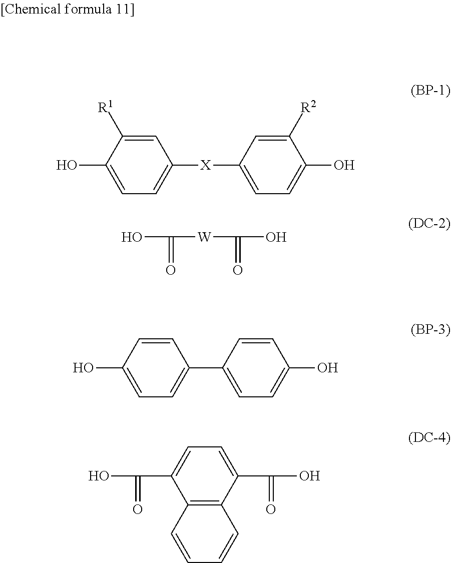

In production of the resin (PA), the percentage content (3) can be adjusted by changing the amount (unit: mol) of the compound (BP-3) added to the total (unit: mol) of the amounts of the compounds (BP-1) and (BP-3) added. Also, the percentage content (4) can be adjusted by changing the amount (unit: mol) of the compound (DC-4) added to the total (unit: mol) of the amounts of the compounds (DC-2) and (DC-4) added.

The bisphenol may be derivatized into aromatic diacetate for use. The dicarboxylic acid may be derivatized for use. Examples of a derivative of the dicarboxylic acid include dicarboxylic acid dichloride, dicarboxylic acid dimethyl ester, dicarboxylic acid diethyl ester, and dicarboxylic acid anhydride. The dicarboxylic acid dichloride is a compound with two “—C(═O)—OH” groups of dicarboxylic acid each substituted with a “—C(═O)—Cl” group.

In condensation polymerization of the bisphenol and the dicarboxylic acid, a terminator may be added. Examples of the terminator include 2,6-dimethylphenol and 1H,1H-perfluoro-1-heptanol. Use of 2,6-dimethylphenol as the terminator can form the end group (T-DMP). Use of 1H,1H-perfluoro-1-heptanol as the terminator can form the end group (T-PFH).

In condensation polymerization of the bisphenol and the dicarboxylic acid, either or both a base and a catalyst may be added. An examples of the base is sodium hydroxide. Examples of the catalyst include benzyltributylammonium chloride, ammonium chloride, ammonium bromide, quaternary ammonium salt, triethylamine, and trimethylamine.

### <Second Resin>

As a result of the photosensitive layer containing the second resin, adhesiveness of the photosensitive layer to a surface in contact with the photosensitive layer increases, thereby inhibiting film peeling. Furthermore, as a result of the photosensitive layer containing the second resin, sensitivity characteristics of the photosensitive member increase.

The second resin is a polyester resin. The second resin is a polyester resin different from the first resin, that is, a polyester resin other than the resin (PA). The second resin differs from the first resin in at least one condition selected from the group consisting of: a condition that the repeating unit (1) is included; a condition that the repeating unit (2) is included; a condition that the repeating unit (3) is included; a condition that the repeating unit (4) is included; and a condition that the percentage content (3) is greater than 0% and less than 20%. Alternatively, the second resin differs from the first resin in that the second resin has a Vickers hardness different from the Vickers hardness of the first resin.

The polyester resin being the second resin can be obtained by condensation polymerization of one or more polyhydric alcohol monomers and one or more polybasic carboxylic acid monomers. The polyester resin being the second resin is a polymer of one or more polyhydric alcohol monomers and one or more polybasic carboxylic acid monomers.

Examples of the polyhydric alcohol monomers include diol monomers, bisphenol monomers, and tri- or higher-hydric alcohol monomers.

Examples of the diol monomers include ethylene glycol, diethylene glycol, triethylene glycol, 1,2-propanediol, 1,3-propanediol, 1,4-butanediol, neopentyl glycol, 2-butene-1,4-diol, 1,5-pentanediol, 1,6-hexanediol, 1,4-cyclohexanedimethanol, 1,4-benzenediol, dipropylene glycol, polyethylene glycol, polypropylene glycol, and polytetramethylene glycol.

Examples of the bisphenol monomers include bisphenol A, hydrogenated bisphenol A, bisphenol A ethylene oxide adduct, and bisphenol A propylene oxide adduct.

Examples of the tri- or higher-hydric alcohol monomers include sorbitol, 1,2,3,6-hexanetetrol, 1,4-sorbitan, pentaerythritol, dipentaerythritol, tripentaerythritol, 1,2,4-butanetriol, 1,2,5-pentanetrioll, glycerol, diglycerol, 2-methylpropanetriol, 2-methyl-1,2,4-butanetriol, trimethylolethane, trimethylolpropane, and 1,3,5-trihydroxymethylbenzene.

Examples of the polybasic carboxylic acid monomers include dibasic carboxylic acid monomers and tri- or higher-basic carboxylic acid monomers.

Examples of the dibasic carboxylic acid monomers include maleic acid, fumaric acid, citraconic acid, itaconic acid, glutaconic acid, phthalic acid, isophthalic acid, terephthalic acid, 5-sulfoisophthalic acid, 5-sodium sulfoisophthalic acid, cyclohexane dicarboxylic acid, adipic acid, sebacic acid, azelaic acid, malonic acid, succinic acid, alkyl succinic acids, and alkenyl succinic acids. Examples of the alkyl succinic acids include n-butylsuccinic acid, isobutylsuccinic acid, n-octylsuccinic acid, n-dodecylsuccinic acid, and isododecylsuccinic acid. Examples of the alkenyl succinic acids include n-butenylsuccinic acid, isobutenylsuccinic acid, n-octenylsuccinic acid, n-dodecenylsuccinic acid, and isododecenylsuccinic acid.

Examples of the tri- or higher-basic carboxylic acid monomers include 1,2,4-benzenetricarboxylic acid (trimellitic acid), 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, and empor trimeric acid.

The polyester resin being the second resin has a glass transition point of preferably at least 45° C. and no greater than 100° C., and more preferably at least 47° C. and no greater than 95° C. The polyester resin being the second resin has a number average molecular weight of preferably at least 10,000 and no greater than 30,000, and more preferably at least 16,000 and no greater than 17,000. The polyester resin being the second resin has a hydroxyl value of preferably at least 1 mgKOH/g and no greater than 10 mgKOH/g, and more preferably at least 6 mgKOH/g and no greater than 7 mgKOH/g. The polyester resin being the second resin has an acid value of preferably at least 0.1 mgKOH/g and no greater than 10 mgKOH/g, more preferably at least 0.1 mgKOH/g and no greater than 5 mgKOH/g, and further preferably at least 0.1 mgKOH/g and no greater than 2 mgKOH/g.

The first resin is contained in the same layer as the second resin. When the photosensitive member is a multi-layer photosensitive member, the first resin and the second resin are contained in the charge transport layer being the same layer. When the photosensitive member is a single-layer photosensitive member, the first resin and the second resin are contained in the single-layer photosensitive member being a single layer. The photosensitive layer may contain one type of the second resin or two or more types of the second resin.

### <Second Resin Percentage Content>

The second resin has a percentage content of at least 1% and no greater than 3% to the total mass of the first resin and the second resin. In the following, the “percentage content of the second resin to the total mass of the first resin and the second resin” may be also referred to below as “second resin percentage content”. The second resin percentage content is calculated using an equation “(second resin percentage content)=100×(mass of second resin)/((mass of first resin)+(mass of second resin))”. Note that when the photosensitive layer contains two or more types of the first resin, the mass of the first resin is the total mass of the two or more types of the first resin. When the photosensitive layer contains two or more types of the second resin, the mass of the second resin is the total mass of the two or more types of the second resin.

As a result of the second resin percentage content being at least 1%, film peeling of the photosensitive member can be inhibited. As a result of the second resin percentage content being no greater than 3%, abrasion resistance of the photosensitive member increases.

### <Vickers Hardness>

In the present embodiment, the term Vickers hardness is a Vickers hardness at 45° C. The Vickers hardness is measured according to a method in compliance with the Japanese Industrial Standard (JIS) Z2244.

In order to increase adhesiveness of the photosensitive layer to a surface in contact with the photosensitive layer and inhibit film peeling, the second resin preferably has a lower Vickers hardness than the first resin. The second resin with low Vickers hardness imparts moderate elasticity to the photosensitive layer to increase adhesiveness of the photosensitive layer to a surface in contact with the photosensitive layer.

In order to inhibit film peeling of the photosensitive member, the second resin has a Vickers hardness of at least 10.0 HV and no greater than 20.0 HV, and more preferably at least 15.5 HV and no greater than 16.5 HV.

In order to inhibit film peeling of the photosensitive member, the first resin has a Vickers hardness of preferably at least 25.0 HV and no greater than 40.0 HV, more preferably at least 30.0 HV and no greater than 35.0 HV, further preferably at least 30.5 HV and no greater than 33.5 HV, and furthermore preferably at least 33.0 HV and no greater than 33.5 HV.

In order to inhibit film peeling of the photosensitive member, the photosensitive layer has a Vickers hardness of preferably at least 24.0 HV and no greater than 40.0 HV, more preferably at least 29.0 HV and no greater than 34.0 HV, further preferably at least 30.0 HV and no greater than 33.5H V, and furthermore preferably at least 33.0 HV and no greater than 33.5 HV. In the multi-layer photosensitive member, the Vickers hardness of the charge transport layer corresponds to the Vickers hardness of the photosensitive layer. In the single-layer photosensitive member, the Vickers hardness of the single-layer photosensitive member corresponds to the Vickers hardness of the photosensitive layer.

In order to inhibit film peeling of the photosensitive member, a difference (H₁-H₂) between a Vickers hardness H₁ of the first resin and a Vickers hardness H₂ of the second resin is preferably at least 14.5 HV, more preferably at least 15.0 HV, further preferably at least 15.5 HV, furthermore preferably at least 16.0 HV, still further preferably at least 16.5HV, and particularly preferably at least 16.6 HV. In order to inhibit film peeling of the photosensitive member, the difference (H₁-H₂) between the Vickers hardness H1 of the first resin and the Vickers hardness H₂ of the second resin is preferably no greater than 18.0 HV, more preferably no greater than 17.5 HV, further preferably no greater than 17.1 HV, and furthermore preferably no greater than 17.0 HV.

In order to inhibit film peeling of the photosensitive member, the Vickers hardness of the photosensitive layer is preferably lower than the Vickers hardness of the first resin. In order to inhibit film peeling of the photosensitive member, a difference (H₁-H_{P}) between the Vickers hardness H₁ of the first resin and a Vickers hardness H_{P} of the photosensitive layer is preferably at least 0.2 HV and no greater than 1.0 HV. In order to inhibit film peeling of the photosensitive member, the difference (H₁-H_{P}) between the Vickers hardness H₁ of the first resin and the Vickers hardness H_{P} of the photosensitive layer is also preferably within a range between two values selected from the group consisting of 0.2 HV, 0.3 HV, 0.4 HV, 0.5 HV, 0.6 HV, 0.7 HV, 0.8 HV, 0.9 HV, and 1.0 HV.

### <Base Resin>

Examples of the base resin include thermoplastic resins (specific examples include polyarylate resin, polycarbonate resin, styrene-based resin, styrene-butadiene copolymers, styrene-acrylonitrile copolymers, styrene-maleic acid copolymers, styrene-acryl acid copolymers, acryl copolymers, polyethylene resin, ethylene-vinyl acetate copolymers, chlorinated polyethylene resin, polyvinyl chloride resin, polypropylene resin, ionomer, vinyl chloride-vinyl acetate copolymers, polyester resin, alkyd resin, polyamide resin, polyurethane resin, polysulfone resin, diallyl phthalate resin, ketone resin, polyvinyl butyral resin, polyvinyl acetal resin, and polyether resin), thermosetting resins (specific examples include silicone resin, epoxy resin, phenolic resin, urea resin, melamine resin, and any crosslinkable thermosetting resins other than the above), and photocurable resins (specific examples include epoxy-acrylic acid-based resin and urethane-acrylic acid-based copolymers). In order to favorably form the charge generating layer and the charge transport layer, the base resin preferably differs from the first resin and the second resin.

### <Hole Transport Material>

Examples of the hole transport material include triphenylamine derivatives, diamine derivatives (e.g., an N,N,N′,N′-tetraphenylbenzidine derivative, an N,N,N′,N′-tetraphenylphenylenediamine derivative, an N,N,N′,N′-tetraphenylnaphtylenediamine derivative, an N,N,N′,N′-tetraphenylphenanthrylenediamine derivative, and a di(aminophenylethenyl)benzene derivative), oxadiazole-based compounds (e.g., 2,5-di(4-methylaminophenyl)-1,3,4-oxadiazole), styryl-based compounds (e.g., 9-(4-diethylaminostyryl)anthracene), carbazole-based compounds (e.g., polyvinyl carbazole), organic polysilane compounds, pyrazoline-based compounds (e.g., 1-phenyl-3-(p-dimethylaminophenyl)pyrazoline), hydrazone-based compounds, indole-based compounds, oxazole-based compounds, isoxazole-based compounds, thiazole-based compounds, thiadiazole-based compounds, imidazole-based compounds, pyrazole-based compounds, and triazole-based compounds. The photosensitive layer may contain one type of the hole transport material or contain two or more types of the hole transport material.

A preferable example of the hole transport material is a compound represented by formula (21) (also referred to below as hole transport material (21)). As a result of the photosensitive layer containing the hole transport material (21) together with the first resin and the second resin, the photosensitive layer can be further favorably formed, abrasion resistance of the photosensitive member further increases, and film peeling can be further inhibited.

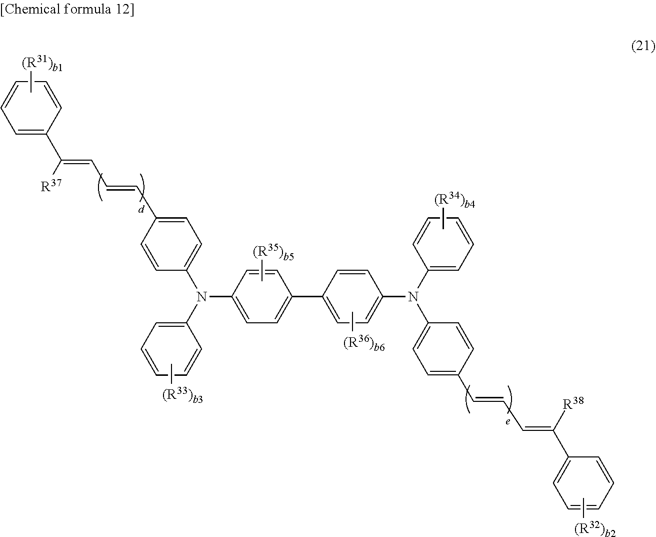

In formula (21), R³¹, R³², R³³, R³⁴, R³⁵, and R³⁶ each represent, independently of one another, a phenyl group or an alkyl group with a carbon number of at least 1 and no greater than 8. R³⁷ and R³⁸ each represent, independently of one another, a hydrogen atom, a phenyl group, or an alkyl group with a carbon number of at least 1 and no greater than 8. b1, b2, b3, and b4 each represent, independently of one another, an integer of at least 0 and no greater than 5. b5 and b6 each represent, independently of one another, an integer of at least 0 and no greater than 4. d and e each represent, independently of one another, 0 or 1.

In formula (21), the chemical groups R³¹ may be the same group as or different groups from each other when b1 represents an integer of at least 2 and no greater than 5. When b2 represents an integer of at least 2 and no greater than 5, the chemical groups R³² may be the same group as or different groups from each other. When b3 represents an integer of at least 2 and no greater than 5, the chemical groups R³³ may be the same group as or different groups from each other. When b4 represents an integer of at least 2 and no greater than 5, the chemical groups R³⁴ may be the same group as or different groups from each other. When b5 represents an integer of at least 2 and no greater than 4, the chemical groups R³⁵ may be the same group as or different groups from each other. When b6 represents an integer of at least 2 and no greater than 4, the chemical groups R³⁶ may be the same group as or different groups from each other.

In formula (21), R³¹ to R³⁶ each represent, independently of one another, preferably, an alkyl group with a carbon number of at least 1 and no greater than 8, more preferably an alkyl group with a carbon number of at least 1 and no greater than 3, and further preferably a methyl group or an ethyl group. Preferably, R³⁷ and R³⁸ each represents a hydrogen atom. Preferably, b1, b2, b3, and b4 each represent, independently of one another, an integer of at least 0 and no greater than 2. Preferably, b5 and b6 each represent 0.

A more preferable example of the hole transport material is a compound represented by formula (HTM-1) (also referred to below as hole transport material (HTM-1)).

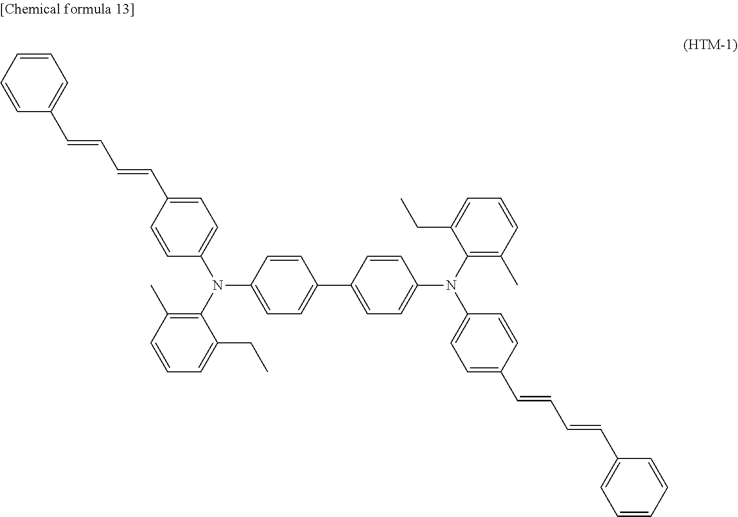 [SMILES: CCc1cccc(C)c1N(c1ccc(/C=C/C=C/c2ccccc2)cc1)c1ccc(-c2ccc(N(c3ccc(/C=C/C=C/c4ccccc4)cc3)c3c(C)cccc3CC)cc2)cc1]

When the photosensitive member is a multi-layer photosensitive member, the hole transport material has a content ratio of preferably at least 10 parts by mass and no greater than 200 parts by mass to 100 parts by mass of the binder resin, more preferably at least 20 parts by mass and no greater than 100 parts by mass, and further preferably at least 40 parts by mass and no greater than 60 parts by mass. When the photosensitive member is a single-layer photosensitive member, the hole transport material has a content ratio of preferably at least 50 parts by mass and no greater than 200 parts by mass to 100 parts by mass of the binder resin, and more preferably at least 50 parts by mass and no greater than 70 parts by mass.

### <Charge Generating Material>

Examples of the charge generating material include phthalocyanine-based pigments, perylene-based pigments, bisazo pigment, tris-azo pigment, dithioketopyrrolopyrrole pigment, metal-free naphthalocyanine pigment, metal naphthalocyanine pigment, squaraine pigment, indigo pigment, azulenium pigment, cyanine pigment, powders of inorganic photoconductive materials (e.g., selenium, selenium-tellurium, selenium-arsenic, cadmium sulfide, and amorphous silicon), pyrylium pigment, anthanthrone-based pigments, triphenylmethane-based pigments, threne-based pigments, toluidine-based pigments, pyrazoline-based pigments, and quinacridone-based pigments. The photosensitive layer may contain one type of the charge generating material or contain two or more types of the charge generating material.

The phthalocyanine-based pigments are pigments with phthalocyanine structure. Examples of the phthalocyanine-based pigments include metal-free phthalocyanine and metal phthalocyanines. Examples of the metal phthalocyanines include titanyl phthalocyanine, hydroxygallium phthalocyanine, and chlorogallium phthalocyanine. The metal-free phthalocyanine is represented by formula (CGM-1). Titanyl phthalocyanine is represented by formula (CGM-2).

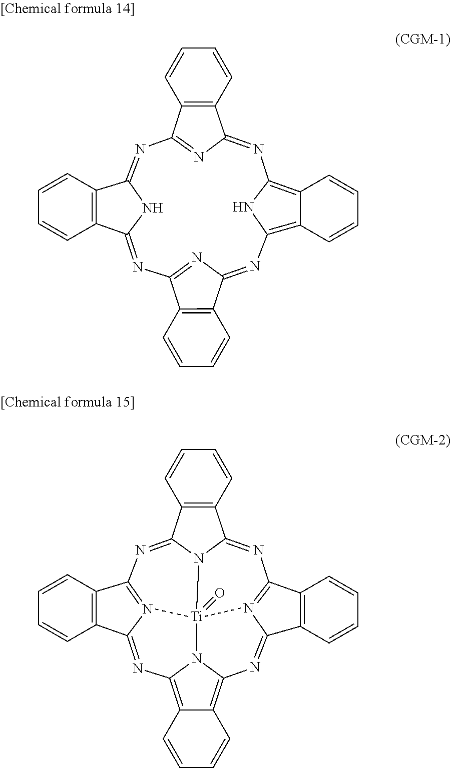

The phthalocyanine-based pigments may be crystallin or non-crystalline. Examples of crystalline metal-free phthalocyanines include metal-free phthalocyanine with X-form crystal structure (also referred to below as X-form metal-free phthalocyanine). Examples of crystalline titanyl phthalocyanines include titanyl phthalocyanine with any of α-form crystal structure, β-form crystal structure, and Y-form crystal structure (also referred to below as α-from titanyl phthalocyanine, β-form titanyl phthalocyanine, and Y-form titanyl phthalocyanine, respectively).

For example, a photosensitive member having a sensitivity in a wavelength range of at least 700 nm is preferably used for digital optical image forming apparatuses (e.g., laser beam printers or facsimile machines using a light source such as semiconductor laser). In terms of having high quantum yield in a wavelength range of at least 700 nm, the charge generating material is preferably a phthalocyanine-based pigment, more preferably metal-free phthalocyanine or titanyl phthalocyanine, further preferably titanyl phthalocyanine, and particularly preferably Y-form titanyl phthalocyanine.

Y-form titanyl phthalocyanine exhibits a main peak for example at a Bragg angle (2θ±0.2°) of 27.2° on a CuKα characteristic X-ray diffraction spectrum. The term main peak on the CuKα characteristic X-ray diffraction spectrum refers to a most intense or second most intense peak within a range of Bragg angles (2θ±0.2°) from 3° to 40°. Y-form titanyl phthalocyanine has no peaks at 26.2° on the CuKα characteristic X-ray diffraction spectrum.

The CuKα characteristic X-ray diffraction spectrum is plotted by the following method, for example. First, a sample (titanyl phthalocyanine) is loaded into a sample holder of an X-ray diffraction spectrometer (e.g., “RINT (registered Japanese trademark) 1100”, product of Rigaku Corporation) and an X-ray diffraction spectrum is plotted using a Cu X-ray tube under conditions of a tube voltage of 40 kV, a tube current of 30 mA, and a wavelength of CuKα characteristic X-rays of 1.542 Å. The measurement range (20) is for example from 3° to 40° (start angle: 3°, stop angle: 40°), and the scanning speed is for example 10°/min. A main peak on the plotted X-ray diffraction spectrum is determined and a Bragg angle of the main peak is read from the X-ray diffraction spectrum.

When the photosensitive member is a multi-layer photosensitive member, the content ratio of the charge generating material is preferably at least 10 parts by mass and no greater than 300 parts by mass to 100 parts by mass of the base resin, and more preferably at least 100 parts by mass and no greater than 200 parts by mass. When the photosensitive member is a single-layer photosensitive member, the content ratio of the charge generating material is preferably at least 0.1 parts by mass and no greater than 50 parts by mass to 100 parts by mass of the base resin, and more preferably at least 0.5 parts by mass and no greater than 30 parts by mass.

### <Additive>

Examples of the additive include an ultraviolet absorbing agent, an antioxidant, a radical scavenger, a singlet quencher, a softener, a surface modifier, an extender, a thickener, a dispersion stabilizer, a wax, a donor, a surfactant, a plasticizer, a sensitizer, an electron acceptor compound, and a leveling agent. The leveling agent is preferably silicone oil, and more preferably silicone oil with dimethylpolysiloxane structure.

### <Conductive Substrate>

The conductive substrate is not limited particularly so long as at least the surface portion thereof is constituted by a conductive material. An example of the conductive substrate is a conductive material constituted by a conductive material. Another example of the conductive substrate is a conductive substrate covered with a conductive material. Examples of the conductive material include aluminum, iron, copper, tin, platinum, silver, vanadium, molybdenum, chromium, cadmium, titanium, nickel, palladium, indium, stainless steel, and brass. Among the conductive materials listed above, aluminum or an aluminum alloy is preferable in terms of favorable charge mobility from the photosensitive layer to the conductive substrate.

The conductive substrate may have any shape and the shape thereof can be selected as appropriate according to the configuration of an image forming apparatus in which the conductive substrate is to be used. The conductive substrate has a sheet shape or a drum shape, for example. The thickness of the conductive substrate is selected as appropriate according to the shape of the conductive substrate.

### <Intermediate Layer>

The intermediate layer (undercoat layer) contains inorganic particles and a resin (intermediate layer resin) used for intermediate layer use, for example. Provision of the intermediate layer may facilitate flow of electric current generated when the photosensitive member is exposed to light and inhibit increasing resistance, while also maintaining insulation to a sufficient degree so as to inhibit leakage of the electric current from occurring.

Examples of the inorganic particles include particles of metals (e.g., aluminum, iron, and copper), particles of metal oxides (e.g., titanium oxide, alumina, zirconium oxide, tin oxide, and zinc oxide), and particles of non-metal oxides (e.g., silica).

Examples of the intermediate layer resin are the same as those listed as the examples of the additional binder resin described previously. In order to favorably form the intermediate layer and the photosensitive layer, the intermediate layer resin preferably differs from the binder resin contained in the photosensitive layer. The intermediate layer may contain an additive. Examples of the additive contained in the intermediate layer are the same as those listed as the examples of the additive contained in the photosensitive layer.

### <Photosensitive Member Production Method>

The following describes one example of a multi-layer photosensitive member production method and one example of a single-layer photosensitive member production method each as a photosensitive member production method.

The multi-layer photosensitive member production method includes a charge generating layer formation process and a charge transport layer formation process, for example. In the charge generating layer formation process, an application liquid for forming a charge generating layer (also referred to below as application liquid for charge generating layer formation) is prepared first. The application liquid for charge generating layer formation is applied onto a conductive substrate. Next, at least a portion of a solvent contained in the applied application liquid for charge generating layer formation is removed to form a charge generating layer. The application liquid for charge generating layer formation contains a charge generating material, a base resin, and the solvent, for example. The application liquid for charge generating layer formation as above is prepared by dissolving or dispersing the charge generating material and the base resin in the solvent. The application liquid for charge generating layer formation may further contain an additive as necessary.

In the charge transport layer formation process, an application liquid for forming a charge transport layer (also referred to below as application liquid for charge transport layer formation) is prepared first. The application liquid for charge transport layer formation is applied onto the charge generating layer. Next, at least a portion of a solvent contained in the applied application liquid for charge transport layer formation is removed to form a charge transport layer. The application liquid for charge transport layer formation contains a hole transport material, the first resin, the second resin, and the solvent. The application liquid for charge transport layer formation can be prepared by dissolving or dispersing the hole transport material, the first resin, and the second resin in the solvent. The application liquid for charge transport layer formation may further contain an additive as necessary.

The single-layer photosensitive member production method includes a single-layer photosensitive layer formation process, for example. In the single-layer photosensitive layer formation process, an application liquid for forming a single-layer photosensitive layer (also referred to below as application liquid for single-layer photosensitive layer formation) is prepared. The application liquid for single-layer photosensitive layer formation is applied onto a conductive substrate. Next, at least a portion of a solvent contained in the applied application liquid for single-layer photosensitive layer formation is removed to form a single-layer photosensitive layer. The application liquid for single-layer photosensitive layer formation contains a charge generating material, a hole transport material, the first resin, the second resin, and the solvent, for example. The application liquid for single-layer photosensitive layer formation is prepared by dissolving or dispersing the charge generating material, the hole transport material, the first resin, and the second resin in the solvent. The application liquid for single-layer photosensitive layer formation may further contain either or both an electron transport material and an additive as necessary.

No particular limitations are placed on the respective solvents contained in the application liquid for single-layer photosensitive layer formation, the application liquid for charge generating layer formation, and the application liquid for charge transport layer formation (each also referred to below generally as application liquid) so long as each component contained in the application liquids can dissolve or disperse therein. Examples of the solvents include alcohols (specific examples include methanol, ethanol, isopropanol, and butanol), aliphatic hydrocarbons (specific examples include n-hexane, octane, and cyclohexane), aromatic hydrocarbons (specific examples include benzene, toluene, and xylene), halogenated hydrocarbons (specific examples include dichloromethane, dichloroethane, carbon tetrachloride, and chlorobenzene), ethers (specific examples include dimethyl ether, diethyl ether, tetrahydrofuran, ethylene glycol dimethyl ether, and diethylene glycol dimethyl ether), ketones (specific examples include acetone, methyl ethyl ketone, and cyclohexanone), esters (specific examples include ethyl acetate and methyl acetate), dimethyl formaldehyde, dimethyl formamide, and dimethyl sulfoxide.

The solvent contained in the application liquid for charge transport layer formation preferably differs from the solvent contained in the application liquid for charge generating layer formation. This is because it is preferable that the charge generating layer does not dissolve in the solvent for application liquid for charge transport layer formation in application of the application liquid for charge transport layer formation on the charge generating layer.

Each application liquid is prepared by mixing and dispersing the corresponding components in the corresponding solvent. A bead mill, a roll mill, a ball mill, an attritor, a paint shaker, or an ultrasonic disperser can be used for mixing or dispersion, for example.

No particular limitations are placed on the method for applying each application liquid so long as uniform application of the application liquid can be achieved. Examples of the application method include dip coating, spray coating, spin coating, and bar coating.

Examples of the method for removing at least a portion of the solvent contained in the corresponding application liquid include heating, pressure reduction and a combination of heating and pressure reduction. Specific examples include heat treatment (hot air drying) using a high-temperature dryer or a reduced pressure dryer. The temperature of the heat treatment is at least 40° C. and no greater than 150° C., for example. The time for the heat treatment is at least 3 minutes and no greater than 120 minutes, for example.

Note that the photosensitive member production method may further include either or both a process of forming an intermediate layer and a process of forming a protective layer. Any known methods may be selected as appropriate as the process of forming an intermediate layer and the process of forming a protective layer.

### EXAMPLES

The following describes the present invention further in detail using examples. However, the present invention is not limited to the scope of the examples.

### <First Resin Preparation>

Resins (1-A) to (1-I) used in Examples and resins (1-J) to (1-N) used in Comparative Examples were synthesized by the methods described below. The compositions of the resins (1-A) to (1-N) are shown below in Table 3. The resins (1-A) to (1-N) were each used as the first resin in multi-layer photosensitive member production described later.

TABLE 3

| | Bisphenol | | | | Dicarboxylic acid | | | | | |
|---|---|---|---|---|---|---|---|---|---|---|
| | addition rate [%] | | | | addition rate [%] | | | | | |
| Monomer | BisCZ | BisB | BisZ | BP | 14NACC | 26NACC | DPEC | TPC/IPC | | |
| Formation | Unit | Unit | Unit | Unit | Unit | Unit | Unit | Unit | | Molecular |
| unit | (1-1) | (1-2) | (1-3) | (3) | (4) | (2-1) | (2-2) | (TPC/IPC) | Terminator | weight |
| Resin 1-A | 95 | — | — | 5 | 50 | 50 | — | — | DMP | 55400 |
| Resin 1-B | — | 95 | — | 5 | 50 | 50 | — | — | DMP | 64200 |
| Resin 1-C | 90 | — | — | 10 | 50 | 50 | — | — | DMP | 54500 |
| Resin 1-D | 81 | — | — | 19 | 50 | 50 | — | — | DMP | 52700 |
| Resin 1-E | — | 81 | — | 19 | 50 | 50 | — | — | DMP | 62300 |
| Resin 1-F | 95 | — | — | 5 | 35 | 65 | — | — | DMP | 58000 |
| Resin 1-G | 95 | — | — | 5 | 65 | 35 | — | — | DMP | 54300 |
| Resin 1-H | 95 | — | — | 5 | 50 | 50 | — | — | PFH | 56800 |
| Resin 1-I | 95 | — | — | 5 | 50 | — | 50 | — | DMP | 58500 |
| Resin 1-J | 50 | — | — | 50 | 50 | 50 | — | — | DMP | Unmeasurable |
| Resin 1-K | 100 | — | — | — | 50 | 50 | — | — | DMP | 55900 |
| Resin 1-L | 95 | — | — | 5 | — | — | — | 50/50 | DMP | 50200 |
| Resin 1-M | — | — | 80 | 20 | — | — | 100 | — | DMP | Unmeasurable |
| Resin 1-N | 100 | — | — | — | — | 50 | 50 | — | DMP | 57300 |

In Table 3, “BisCZ”, “BisB”, “BisZ”, “BP”, “14NACC”, “26NACC”, “DPEC”, “TPC”, and “JPC” are respectively compounds represented by the following formulas (BisCZ), (BisB), (BisZ), (BP), (14NACC), (26NACC), (DPEC), (TPC), and (IPC) (also referred to below as compounds (BisCZ), (BisB), (BisZ), (BP), (14NACC), (26NACC), (DPEC), (TPC), and (IPC), respectively).

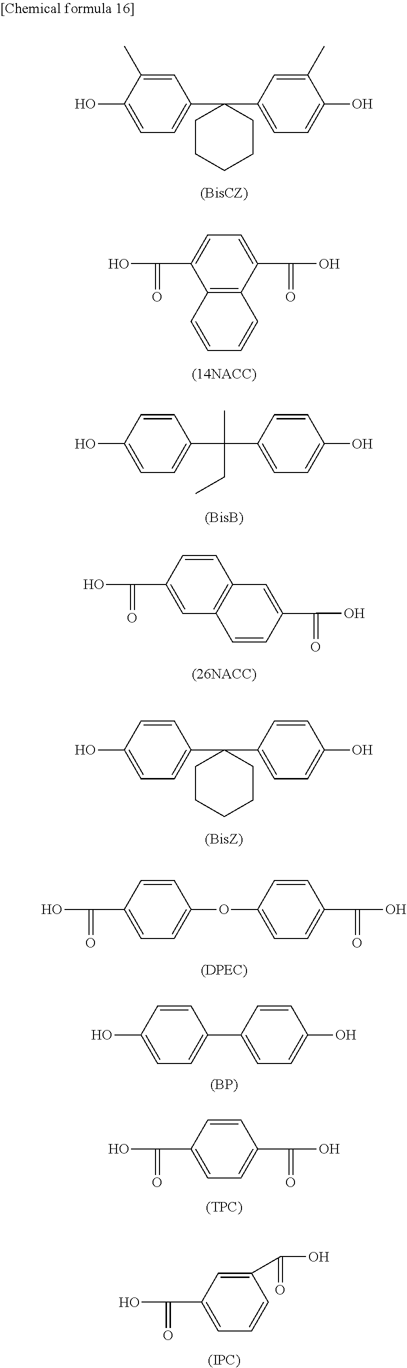

Furthermore, the terms in Table 3 mean as follows.

Monomer: monomer used for resin synthesis

Formation unit: repeating unit formed from corresponding monomer

Resins 1-A to 1-N: resins (1-A) to (1-N)

Bisphenol addition rate: percentage (unit: %) of amount (unit: mol) of corresponding bisphenol monomer to total amount (unit: mol) of bisphenol monomers added in resin synthesis

Dicarboxylic acid addition rate: percentage (unit: %) of amount (unit: mol) of corresponding dicarboxylic acid monomer to total amount (unit: mol) of dicarboxylic acid monomers added in resin synthesis

Molecular weight: viscosity average molecular weight

Unit: repeating unit

TPC/IPC: mixture of compounds (TPC) and (IPC) at a molar ratio of 1/1

50/50 in column TPC/IPC: dicarboxylic acid addition rate in compound (TPC) being 50% and dicarboxylic acid addition rate in compound (IPC) being 50%

DMP: 2,6-dimethylphenol

PFH: 1H,1H-perfluoro-1-heptanol

Unmeasurable: viscosity average molecular weight not being measured due to corresponding resin not having dissolved in solvent for viscosity molecular weight measurement use

−: nonuse of corresponding monomer

### (Synthesis of Resin (1-A))

A three-necked flask equipped with a thermometer, a three-way cock, and a dropping funnel was used as a reaction vessel. The reaction vessel was charged with the compound (BisCZ) (38.95 mmol) being a monomer, the compound (BP) (2.05 mmol) being a monomer, 2,6-dimethylphenol (0.413 mmol) being a terminator, sodium hydroxide (98 mmol), and benzyltributylammonium chloride (0.384 mmol). The air in the reaction vessel was replaced with an argon gas. Water (300 mL) was added to the contents of the reaction vessel. The contents of the reaction vessel were stirred at 50° C. for 1 hour. The contents of the reaction vessel were cooled to 10° C. Thus, an alkaline aqueous solution S-A was obtained.

Next, dicarboxylic acid dichloride (16.0 mmol) of the compound (14NACC) being a monomer and carboxylic acid dichloride (16.0 mmol) of the compound (26NACC) being a monomer were dissolved in chloroform (150 mL). Through the above, a chloroform solution S-B was obtained.

Using a dropping funnel, the chloroform solution S-B was slowly dripped into the alkaline aqueous solution S-A over 110 minutes. While the temperature (liquid temperature) of the contents of the reaction vessel was adjusted to 15±5° C., the contents of the reaction vessel were stirred for 4 hours to allow a polymerization reaction to proceed. The upper layer (water layer) of the contents of the reaction vessel was removed using a decant, thereby obtaining an organic layer. Next, ion exchange water (400 mL) was added into a conical flask. The resultant organic layer was further added into the conical flask. Chloroform (400 mL) and acetic acid (2 mL) were further added into the conical flask. The contents of the conical flask were stirred at room temperature (25° C.) for 30 minutes. The upper layer (water layer) of the contents of the conical flask was removed using a decant, thereby obtaining an organic layer. The resultant organic layer was washed with ion exchange water (1 L) using a separatory funnel. The washing with ion exchange water was repeated 5 times, thereby obtaining a washed organic layer. Next, the washed organic layer was filtered, thereby obtaining a filtrate. The resultant filtrate was slowly dripped into methanol (1 L), thereby obtaining a precipitate. The precipitate was taken out by filtration. The taken precipitate was vacuum dried at a temperature of 70° C. for 12 hours. As a result, the resin (1-A) was obtained.

### (Synthesis of Resins (1-B) to (1-N))

The resins (1-B) to (1-N) were synthesized according to the same method as that for synthesizing the resin (1-A) in all aspects other than that the monomers shown in Table 3 were used at corresponding addition rates shown in Table 3. Note that the amount of each bisphenol monomer added was set so that the total amount of the corresponding bisphenol monomers reached 41.0 mmol and the bisphenol monomers had corresponding bisphenol addition rates shown in Table 3. For example, in the synthesis of the resin (1-B), the amount of the compound (BisB) added was 38.95 mmol (=41.0×95/100) and the amount of the compound (BP) added was 2.05 mmol (=41.0×5/100). Furthermore, the amount of each dicarboxylic acid monomer added was set so that the total amount of the corresponding dicarboxylic acid monomers reached 32.0 mmol and the dicarboxylic acid monomers had corresponding dicarboxylic acid addition rates shown in Table 3. For example, in the synthesis of the resin (1-B), the amount of the compound (14NACC) added was 16.0 mmol (=32.0×50/100) and the amount of the compound (26NACC) added was 16.0 mmol (=32.0×50/100).

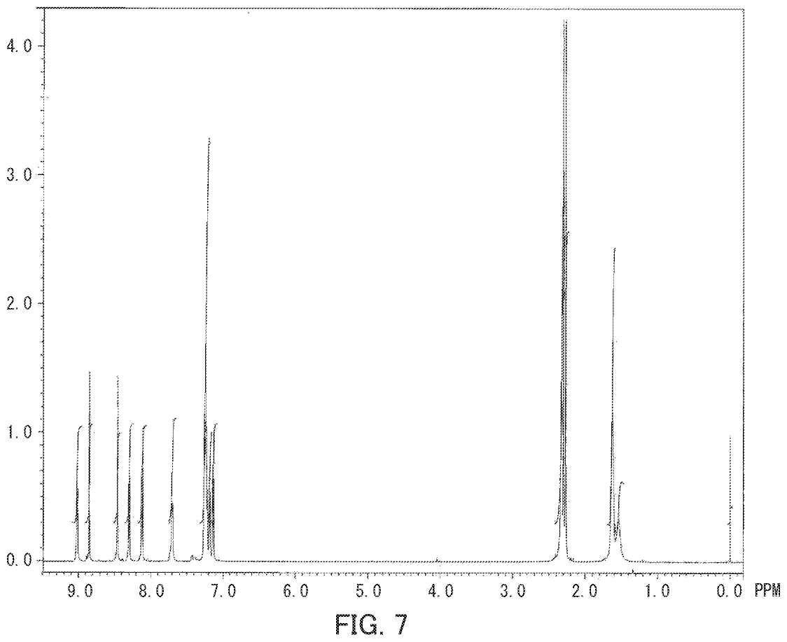

Using a proton nuclear magnetic resonance spectrometer (product of JEOL Ltd., 600 MHz), a ¹H-NMR spectrum of each of the resultant resins (1-A) to (1-N) was plotted. Deuterated chloroform was used as a solvent. Tetramethylsilane (TMS) was used as an internal standard sample. The ¹H-NMR spectrum of the resin (1-H) was shown in FIG. 7 as a typical examples of the resins (1-A) to (1-N). It was confirmed based on the chemical shift read from the ¹H-NMR spectrum that the resin (1-H) has been obtained. It was also confirmed by the same method as above that the resins (1-A) to (1-G) and (1-I) to (1-N) have been obtained.

### (Preparation of Resin (1-O))

A resin (1-O) was prepared for use in Comparative Examples. The resin (1-O) is represented by the following formula (1-O). The number appended to the lower right of each repeating unit derived from bisphenol in formula (1-O) indicates a percentage content (unit: %) of the repeating unit derived from bisphenol to the total number of repeats of the repeating units derived from bisphenol included in the resin (1-O). Furthermore, the number appended to the lower right of each repeating unit derived from dicarboxylic acid in formula (1-O) indicates a percentage content (unit: %) of the repeating unit derived from dicarboxylic acid to the total number of repeats of the repeating units derived from dicarboxylic acid included in the resin (1-O). The resin (1-O) included an end group derived from 2,6-dimethylphenol as an end group. The resin (1-O) had a viscosity average molecular weight of 54,400.

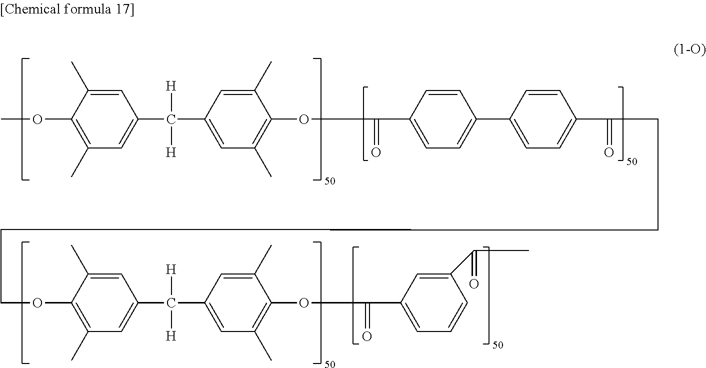

### <Viscosity Average Molecular Weight Measurement of First Resin>

The viscosity average molecular weight of the first resin was measured in accordance with the Japanese Industrial Standards (JIS) K7252-1:2016. The measured viscosity average molecular weights of the resins (1-A) to (1-N) are shown above in Table 3. The viscosity average molecular weight of the resin (1-O) was as indicated above.

### <Evaluation of Solubility of First Resin in Solvent>

In an environment at a temperature of 22° C., 3 g of one of the first resins and tetrahydrofuran in such an amount that the concentration of the first resin reached 15% by mass were stirred for 60 minutes, thereby obtaining an evaluation liquid. The evaluation liquid was visually observed and solubility of the resin in the tetrahydrofuran being a solvent was evaluated according to the following criteria. First resins rated A or B were evaluated to have good solubility in the solvent, and first resins rated C were evaluated to have poor solubility in the solvent. Evaluation results are shown in Table 4.

### (Evaluation Criteria of Solubility in Solvent)

A: The first resin was completely dissolved in the tetrahydrofuran and neither clouding nor gelling of the evaluation liquid was observed.

B: Clouding of the evaluation liquid was observed but gelling of the evaluation liquid was not observed.

C: Gelling of the evaluation liquid was observed.

TABLE 4

| Resin | Solubility |
|---|---|
| 1-A | A |
| 1-B | A |
| 1-C | A |
| 1-D | A |
| 1-E | A |
| 1-F | A |
| 1-G | A |
| 1-H | A |
| 1-I | A |
| 1-J | C |
| 1-K | A |
| 1-L | A |
| 1-M | C |
| 1-N | A |
| 1-O | A |

### <Second Resin Preparation>

The following resins (R-1) to (R-4) were prepared each as the second resin used in multi-layer photosensitive member production. The resins (R-1) to (R-4) each were a polyester resin different from the resin (PA).

Resin (R-1): polyester resin (“VYLON (registered Japanese trademark) 200” produced by TOYOBO CO., LTD., glass transition point: 67° C., number average molecular weight: 17,000, hydroxyl value: 6 mgKOH/g, acid value: less than 2 mgKOH/g)

Resin (R-2): polyester resin (“VYLON (registered Japanese trademark) 600” produced by TOYOBO CO., LTD., glass transition point: 47° C., number average molecular weight: 16,000, hydroxyl value: 7 mgKOH/g, acid value: less than 2 mgKOH/g)

Resin (R-3): polyester resin (“VYLON (registered Japanese trademark) GK-360” produced by TOYOBO CO., LTD., glass transition point: 56° C., number average molecular weight: 16,000, hydroxyl value: 7 mgKOH/g, acid value: 5 mgKOH/g)

Resin (R-4): polyester resin (“ALTESTER (registered Japanese trademark) S2000” produced by MITSUBISHI GAS CHEMICAL COMPANY, INC., glass transition point: 95° C.)

### <Multi-Layer Photosensitive Member Production>

### (Production of Multi-layer Photosensitive Member (A-1))

First, an intermediate layer was formed. Surface treated titanium oxide (“Protype SMT-A”, product of TAYCA CORPORATION, number average primary particle diameter 10 nm) was prepared. SMT-A was titanium oxide obtained by surface treating titanium oxide with alumina and silica and further surface treating the surface treated titanium oxide with methyl hydrogen polysiloxane under wet dispersion. Next, 2 parts by mass of SMT-A, 1 part by mass of a polyamide resin (“AMILAN (registered Japanese trademark) CM8000”, product of Toray Industries, Inc., quaternary copolymerized polyamide resin of polyamide 6, polyamide 12, polyamide 66, and polyamide 610), 10 parts by mass of methanol, 1 part by mass of butanol, and 1 part by mass of toluene were mixed for 5 hours using a bead mill, thereby obtaining an application liquid for intermediate layer formation. The application liquid for intermediate layer formation was filtered using a filter with an opening of 5 μm. Thereafter, the application liquid for intermediate layer formation was applied onto the surface of a conductive substrate by dip coating. The conductive substrate used was a drum-shaped aluminum support. Subsequently, the applied application liquid for intermediate layer formation was dried at 130° C. for 30 minutes, thereby forming an intermediate layer (film thickness: 1.5 μm) on the conductive substrate.

Next, a charge generating layer was formed. In detail, 1.5 parts by mass of Y-form titanyl phthalocyanine being a charge generating material, 1 part by mass of a polyvinyl acetal resin (“S-LEC BX-5”, product of SEKISUI CHEMICAL CO., LTD.) being a base resin, 40 parts by mass of propylene glycol monomethyl ether, and 40 parts by mass of tetrahydrofuran were mixed for 12 hours using a bead mill, thereby obtaining an application liquid for charge generating layer formation. The application liquid for charge generating layer formation was filtered using a filter with an opening of 3 μm. The resultant filtrate was applied onto the intermediate layer by dip coating and dried at 50° C. for 5 minutes. In the manner described above, a charge generating layer (film thickness: 0.3 μm) was formed on the intermediate layer.

Next, a charge transport layer was formed. In detail, 45 parts by mass of the hole transport material (HTM-1) described in the embodiment, 99 parts by mass of the resin (1-A) being the first resin, 1 part by mass of the resin (R-1) being the second resin, 0.07 parts by mass of a silicone oil (“KF96-50cs”, product of Shin-Etsu Chemical Co., Ltd., silicone oil with dimethylpolysiloxane structure), 560 parts by mass of tetrahydrofuran, and 140 parts by mass of toluene were mixed, thereby obtaining an application liquid for charge transport layer formation. The application liquid for charge transport layer formation was applied onto the charge generating layer by dip coating and dried at 120° C. for 40 minutes. In the manner described above, a charge transport layer (film thickness: 30 μm) was formed on the charge generating layer. Thus, a multi-layer photosensitive member (A-1) was obtained. In the multi-layer photosensitive member (A-1), the intermediate layer was provided on the conductive substrate, the charge generating layer was provided on the intermediate layer, and the charge transport layer was provided on the charge generating layer.

### (Production of Multi-Layer Photosensitive Members (A-2) to (A-14) and (B-1) to (B-9))

Multi-layer photosensitive members (A-2) to (A-14) and (B-1) to (B-9) were produced according to the same method as that for producing the multi-layer photosensitive member (A-1) in all aspects other than that the first resins and the second resins shown later in Tables 6 and 7 were used in the amounts shown in Tables 6 and 7.

### <Vickers Hardness Measurement>

First resin layers, second resin layers, and photosensitive layers were prepared each as a Vickers hardness measurement target. The method for preparing each first resin layer being a measurement target was as follows. A first resin solution was obtained by mixing 100 parts by mass of a first resin (any of the resins (1-A) to (1-O)), 560 parts by mass of tetrahydrofuran, and 140 parts by mass of toluene. The first resin solution was applied onto an aluminum substrate by dip coating and dried at 120° C. for 40 minutes. In the manner described above, the first resin layers (film thickness: 30 μm) were obtained.

The method for preparing each second resin layer being a measurement target was as follows. The second resin layers were obtained according to the same method as that for preparing each first resin layer in all aspects other than that the first resin was changed to any of the second resins (resins ((R-1) to (R-4) used in Examples).

The charge transport layers provided in the respective multi-layer photosensitive members obtained in <Multi-layer Photosensitive Member Production> described above were each used as the photosensitive layer being a measurement target.

Next, the Vickers hardness of each measurement target was measured according to a method in compliance with the Japanese Industrial Standard (JIS) Z2244. First, the measurement target was heated using a heater to increase the temperature of the measurement target up to 45° C. Next, the Vickers hardness of the measurement target was measured using a hardness tester (“MICRO VICKERS HARDNESS TESTER TYPE DMH-1”, product of Matsuzawa Co., Ltd.) while the temperature of the measurement target was kept at 45° C. Vickers hardness measurement was carried out under conditions of a load (test force) of a diamond indenter of the hardness tester of 10 gf, a time required to reach the test force of 5 seconds, an approach speed of the diamond indenter of 2 mm/see, and a retention time of the test force of 1 second. Each measured Vickers hardness of the first resin layers and the second resin layers at 45° C. was shown in Table 5. Each measured Vickers hardness of the photosensitive layers at 45° C. was shown later in Tables 6 and 7. In Table 5, “Unmeasurable” means that the Vickers hardness was not measured because the corresponding first resin layer was not formed due to the corresponding first resin not having dissolved in the solution for forming the first resin solution.

TABLE 5

| Resin | | Hardness [HV] |
|---|---|---|
| First resin | 1-A | 32.8 |
| | 1-B | 31.1 |
| | 1-C | 32.4 |
| | 1-D | 32.1 |
| | 1-E | 30.8 |
| | 1-F | 32.5 |
| | 1-G | 33.5 |
| | 1-H | 33.0 |
| | 1-I | 31.9 |
| | 1-J | Unmeasurable |
| | 1-K | 32.7 |
| | 1-L | 30.7 |
| | 1-M | Unmeasurable |
| | 1-N | 31.1 |
| | 1-O | 28.8 |
| Second resin | R-1 | 15.9 |
| | R-2 | 15.6 |
| | R-3 | 15.9 |
| | R-4 | 16.3 |

### <Evaluation of Sensitivity Characteristic>

Sensitivity characteristics of the multi-layer photosensitive members were evaluated using a drum sensitivity test device (product of GENTEC CO., LTD.) in an environment at a temperature of 25° C. and a relative humidity of 50%. In detail, each multi-layer photosensitive member was charged using the drum sensitivity test device so that the surface potential of the multi-layer photosensitive member reached −550 V. Next, the surface of the multi-layer photosensitive member was irradiated with monochromatic light (wavelength: 780 nm, exposure light amount: 1.0 μJ/cm²) taken out of a halogen lamp using a bandpass filter. The surface potential of the multi-layer photosensitive member was measured at a time when 50 milliseconds have elapsed from the monochromatic light irradiation, and the measurement value was taken to be a post-exposure potential (V_{L}, unit: −V). The post-exposure potential of each multi-layer photosensitive member was shown in Tables 6 and 7. From the post-exposure potentials, sensitivity characteristics of the multi-layer photosensitive members were evaluated according to the following criteria.

### (Evaluation Criteria of Sensitivity Characteristics)

Good: absolute value of post-exposure potential of no greater than 90 V
Poor: absolute value of post-exposure potential of greater than 90 V

### <Evaluation of Abrasion Resistance>

The evaluation apparatus used in evaluation of abrasion resistance was a color printer (“C711dn”, product of Oki Data Corporation). A cyan toner was charged into a toner cartridge of the evaluation apparatus. First, a film thickness T1 of the charge transport layer of each multi-layer photosensitive member was measured. Next, the multi-layer photosensitive member was mounted in the evaluation apparatus. Next, an image I (pattern image with a printing rate of 1%) was printed on 10,000 sheets of paper using the evaluation apparatus in a normal-temperature and normal-humidity environment (a temperature of 23° C. and a relative humidity of 50%). Next, the image I was printed on 10,000 sheets of paper using the evaluation apparatus in a high-temperature and high-humidity environment (a temperature of 32° C. and a relative humidity of 85%). Next, the image I was printed on 10,000 sheets of paper using the evaluation apparatus in a low-temperature and low-humidity environment (a temperature of 10° C. and a relative humidity of 15%: also referred to below as LL environment). After the printing in the LL environment, the evaluation apparatus was left to stand for 2 hours. Next, a solid image (solid image with an image density of 100%) was printed on one sheet of paper in the LL environment. Thereafter, a film thickness T2 of the charge transport layer of the multi-layer photosensitive member was measured. An abrasion amount (T1-T2, unit: μm) being a film thickness variation of the charge transport layer between before and after the printing was obtained. The obtained abrasion amounts are shown in Tables 6 and 7. From the abrasion amounts, abrasion resistance of the multi-layer photosensitive members was evaluated according to the following criteria.

### (Evaluation Criteria of Abrasion Resistance)

Good: abrasion amount of no greater than 2.0 μm
Poor: abrasion amount of 2.0 μm

### <Evaluation of Film Peeling Inhibition>

Using a cutter knife, 16 square incision parts with a length of 5 mm and a width of 5 mm were made in an area A of the surface of each multi-layer photosensitive member (specifically, the surface of each charge transport layer). Adhesion tape (“CELLOTAPE (registered Japanese trademark) CT-24”, product of Nichiban Co., Ltd., width: 24 mm) was attached to the area A. The adhesive tape was ripped off in a direction perpendicular to the axial direction of the multi-layer photosensitive member. The number (remaining number) of parts of the 16 incision parts that had remained unripped was counted. The remaining numbers in areas B and C in the surface of the multi-layer photosensitive member were also counted by the same method as that for counting in the area A. Note that the areas A, B, and C were respectively one side area, the other side area, and the intermediate area of the surface of the multi-layer photosensitive member in the axial direction of the multi-layer photosensitive member. The remaining numbers are shown in Tables 6 and 7. From the remaining numbers, film peeling inhibition of the multi-layer photosensitive members was evaluated according to the following criteria.

### (Evaluation Criteria of Film Peeling Inhibition)

Good: remaining number of at least 1
Poor: remaining number of 0

The terms in Tables 6 and 7 mean as follows. “Photosensitive member” means the multi-layer photosensitive members. “Part” means “part by mass”. “Rate” means second resin percentage contents. Because the total amount of a first resin and a second resin is 100 parts by mass, the amount (unit: parts by mass) and the percentage content (unit: %) of the second resin are the same value. As such, the amount and the percentage content of each second resin are shown collectively in the column “Amount [Part] (rate) [%]”. “Hardness” means the Vickers hardness (unit: HV) of the photosensitive layers. “V_{L}” means the post-exposure potentials of the multi-layer photosensitive members. “Remaining number” means remaining numbers in evaluation of film peeing inhibition. “Unmeasurable” means that corresponding measurement or evaluation was not carried out because a corresponding multi-layer photosensitive member was not produced due to a corresponding first resin not having dissolved in the solvent for forming a corresponding application liquid for charge transport layer formation. “−” means no containment of a corresponding component.

TABLE 6

| | | | | Second resin | | | Evaluation | | |
|---|---|---|---|---|---|---|---|---|---|
| | | First resin | | | Amount | | | Remaining | Abrasion |
| | Photosensitive | | Amount | | [part] | Hardness | V_{L} | amount | amount |
| | member | Type | [part] | Type | (Rate [%]) | [HV] | [−V] | [count] | [μm] |
| Example 1 | A-1 | 1-A | 99 | R-1 | 1 | 32.3 | 71 | 2 | 1.2 |
| Example 2 | A-2 | 1-B | 99 | R-1 | 1 | 30.5 | 59 | 4 | 1.2 |
| Example 3 | A-3 | 1-C | 99 | R-1 | 1 | 32.0 | 63 | 3 | 1.4 |
| Example 4 | A-4 | 1-D | 99 | R-1 | 1 | 31.8 | 58 | 5 | 1.5 |
| Example 5 | A-5 | 1-E | 99 | R-1 | 1 | 30.0 | 61 | 5 | 1.4 |
| Example 6 | A-6 | 1-F | 99 | R-1 | 1 | 31.9 | 66 | 2 | 1.0 |
| Example 7 | A-7 | 1-G | 99 | R-1 | 1 | 33.1 | 74 | 2 | 1.2 |
| Example 8 | A-8 | 1-H | 99 | R-1 | 1 | 32.4 | 60 | 2 | 0.9 |
| Example 9 | A-9 | 1-I | 99 | R-1 | 1 | 31.2 | 68 | 3 | 1.8 |
| Example 10 | A-10 | 1-A | 99 | R-2 | 1 | 32.1 | 73 | 2 | 1.1 |
| Example 11 | A-11 | 1-A | 99 | R-3 | 1 | 32.3 | 74 | 1 | 1.4 |
| Example 12 | A-12 | 1-A | 99 | R-4 | 1 | 32.4 | 78 | 2 | 1.3 |
| Example 13 | A-13 | 1-A | 98 | R-1 | 2 | 32.0 | 71 | 3 | 1.5 |
| Example 14 | A-14 | 1-A | 97 | R-1 | 3 | 31.8 | 74 | 5 | 2.0 |

TABLE 7

| | | | | Second resin | | | Evaluation | | |
|---|---|---|---|---|---|---|---|---|---|
| | | First resin | | | Amount | | | Remaining | Abrasion |
| | Photosensitive | | Amount | | [part] | Hardness | V_{L} | amount | amount |
| | member | Type | [part] | Type | (Rate [%]) | (HV) | [−V] | [count] | [μm] |
| Comparative | B-1 | 1-J | 99 | R-1 | 1 | Unmeasurable | Unmeasurable | | |
| Example 1 | | | | | | | | | |
| Comparative | B-2 | 1-K | 99 | R-1 | 1 | 32.3 | 56 | 2 | 2.5 |
| Example 2 | | | | | | | | | |
| Comparative | B-3 | 1-L | 99 | R-1 | 1 | 30.0 | 58 | 2 | 6.0 |
| Example 3 | | | | | | | | | |
| Comparative | B-4 | 1-M | 99 | R-1 | 1 | Unmeasurable | Unmeasurable | | |
| Example 4 | | | | | | | | | |
| Comparative | B-5 | 1-A | 100 | — | — | 32.8 | 105 | 0 | 1.0 |
| Example 5 | | | | | | | | | |
| Comparative | B-6 | 1-A | 96 | R-1 | 4 | 31.1 | 80 | 8 | 3.3 |
| Example 6 | | | | | | | | | |
| Comparative | B-7 | 1-A | 95 | R-1 | 5 | 30.0 | 88 | 12 | 4.5 |
| Example 7 | | | | | | | | | |
| Comparative | B-8 | 1-N | 99 | R-1 | 1 | 30.6 | 60 | 2 | 2.6 |
| Example 8 | | | | | | | | | |
| Comparative | B-9 | 1-O | 99 | R-1 | 1 | 28.0 | 59 | 10 | 5.1 |
| Example 9 | | | | | | | | | |

As shown in Table 3, the resins (1-J) to (1-N) were each not a resin encompassed by the resin (PA). Also, the resin (1-0) was not a resin encompassed by the resin (PA) as can be understood from formula (1-0). As shown in Table 7, the photosensitive layers of the multi-layer photosensitive members (B-1) to (B-4), (B-8), and (B-9) did not contain the resin (PA) as the first resin. Therefore, the resins (1-J) and (1-M) were poor in solubility in the solvent and the photosensitive layers of the multi-layer photosensitive members (B-1) and (B-4) were not favorably formed as shown in Tables 4 and 7. As shown in Table 7, the multi-layer photosensitive members (B-2), (B-3), (B-8), and (B-9) were poor in abrasion resistance.

As shown in Table 7, the photosensitive layer of the multi-layer photosensitive member (B-5) did not contain the second resin. Therefore, the multi-layer photosensitive member (B-5) was rated as poor in both evaluation of sensitivity characteristics and evaluation of film peeling inhibition.

As shown in Table 7, the photosensitive layers of the multi-layer photosensitive members (B-6) and (B-7) each had a second resin percentage content of greater than 3%. Therefore, the multi-layer photosensitive members (B-6) and (B-7) were rated as poor in evaluation of abrasion resistance.

By contrast, the photosensitive layers of the multi-layer photosensitive members (A-1) to (A-14) contained a charge generating material, a hole transport material, a first resin, and a second resin as shown in Table 6. The first resin was contained in the same layer (specifically, a charge transport layer) as the second resin. The second resin percentage content was at least 1% and no greater than 3%. The first resin was the resin (PA). The second resin was a polyester resin different from the first resin. Therefore, the multi-layer photosensitive members (A-1) to (A-14) each included a favorably formed photosensitive layer, were excellent in abrasion resistance, and inhibited film peeling. Furthermore, the multi-layer photosensitive members (A-1) to (A-14) each included a photosensitive layer that was favorably formed without impairing sensitivity characteristics, were excellent in abrasion resistance, and inhibited film peeling.

From the above, it was demonstrated that the photosensitive member of the present invention that encompasses the multi-layer photosensitive members (A-1) to (A-14) includes a favorably formed photosensitive layer, is excellent in abrasion resistance, and can inhibit film peeling.

### INDUSTRIAL APPLICABILITY

The photosensitive member according to the present invention can be utilized in image forming apparatuses.

1. An electrophotographic photosensitive member comprising:
a conductive substrate; and
a photosensitive layer, wherein
the photosensitive layer contains a charge generating material, a hole transport material, a first resin, and a second resin,
the first resin is contained in a same layer as the second resin, the second resin has a percentage content of at least 1% and no greater than 3% to total mass of the first resin and the second resin,
the first resin includes repeating units represented by formulas (1), (2), (3), and (4), the repeating unit represented by the formula (3) has a percentage content of greater than 0% and less than 20% to a total number of repeats of the repeating units represented by the formulas (1) and (3), and
the second resin is a polyester resin different from the first resin: 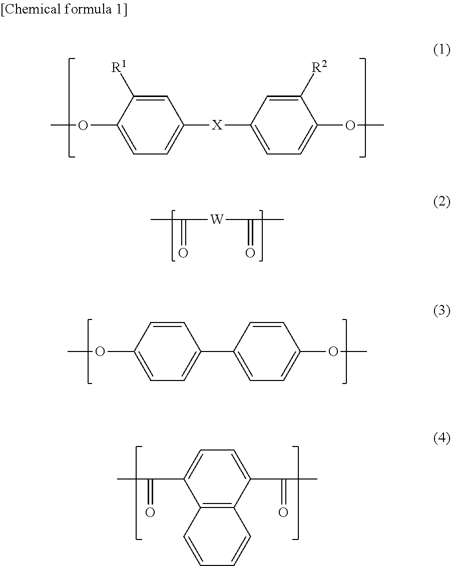
where in the formula (1), R¹ and R² each represent, independently of one another, a hydrogen atom or a methyl group and X represents a divalent group represented by formula (X1) or (X2), and
in the formula (2), W represents a divalent group represented by formula (W1) or (W2): 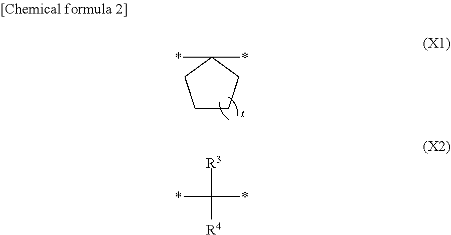
where in the formula (X1), t represents an integer of at least 1 and no greater than 3 and * represents a bond, and
in the formula (X2), R³ and R⁴ each represent a hydrogen atom or an alkyl group with a carbon number of at least 1 and no greater than 4, R³ and R⁴ represent groups different from each other, and * represents a bond: 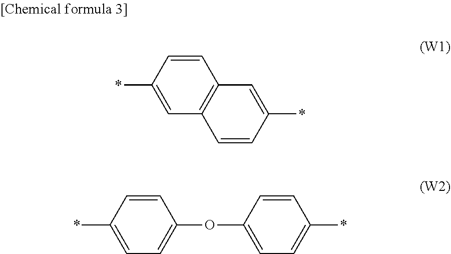 [SMILES: *c1ccc2cc(*)ccc2c1 ; *c1ccc(Oc2ccc(*)cc2)cc1]
where in the formulas (W1) and (W2), * represents a bond.

2. The electrophotographic photosensitive member according to claim 1, wherein
the first resin further includes an end group having a halogen atom.

3. The electrophotographic photosensitive member according to claim 1, wherein
the repeating unit represented by the formula (1) is a repeating unit represented by formula (1-1):

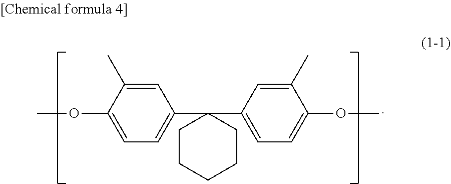

4. The electrophotographic photosensitive member according to claim 1, wherein
the repeating unit represented by the formula (1) is a repeating unit represented by formula (1-1), and the repeating unit represented by the formula (2) is a repeating unit represented by formula (2-1):

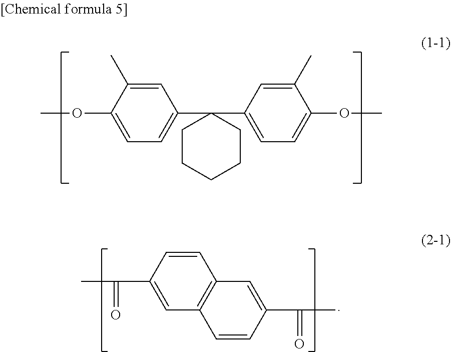

5. The electrophotographic photosensitive member according to claim 1, wherein
the repeating unit represented by the formula (1) is a repeating unit represented by formula (1-1) and the repeating unit represented by the formula (2) is a repeating unit represented by formula (2-2):

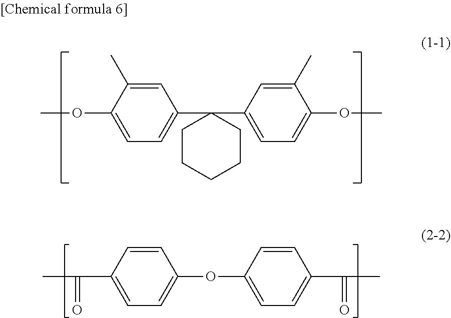

6. The electrophotographic photosensitive member according to claim 1, wherein
the repeating unit represented by the formula (1) is a repeating unit represented by formula (1-2):

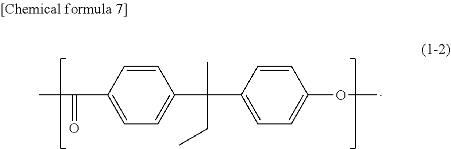

7. The electrophotographic photosensitive member according to claim 6, wherein
the repeating unit represented by the formula (1) is a repeating unit represented by formula (1-2) and the repeating unit represented by the formula (2) is a repeating unit represented by formula (2-1):

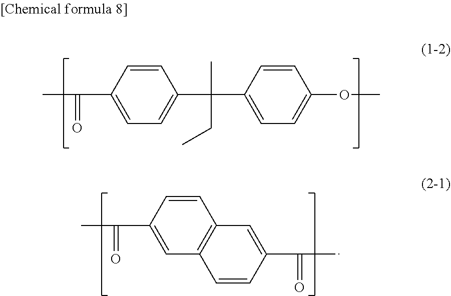

8. The electrophotographic photosensitive member according to claim 1, wherein the second resin has a lower Vickers hardness than the first resin.

9. The electrophotographic photosensitive member according to claim 1, wherein
the second resin has a Vickers hardness of at least 10.0 HV and no greater than 20.0 HV.

10. The electrophotographic photosensitive member according to claim 1, wherein
the first resin has a Vickers hardness of at least 25.0 HV and no greater than 40.0 HV.

11. The electrophotographic photosensitive member according to claim 1, wherein
the photosensitive layer has a Vickers hardness of at least 24.0 HV and no greater than 40.0 HV.

12. The electrophotographic photosensitive member according to claim 1, wherein
the hole transport material includes a compound represented by formula (21): 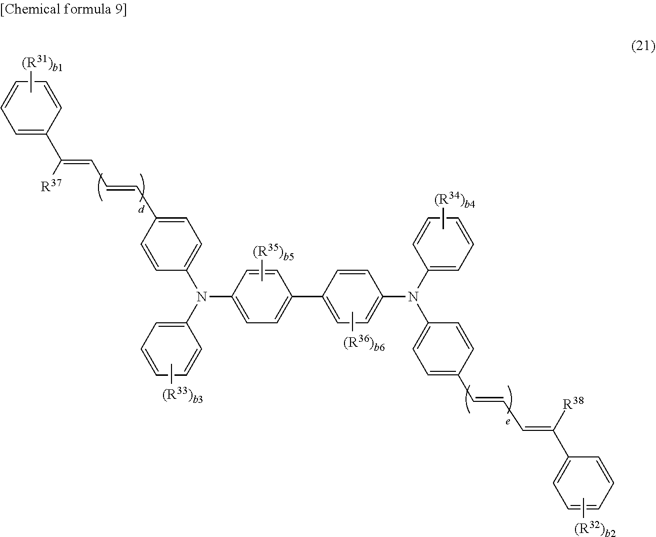
where in the formula (21), R³¹ to R³⁶ each represent, independently of one another, a phenyl group or an alkyl group with a carbon number of at least 1 and no greater than 8, R³⁷ and R³⁸ each represent, independently of one another, a hydrogen atom, a phenyl group, or an alkyl group with a carbon number of at least 1 and no greater than 8, b1, b2, b3, and b4 each represent, independently of one another, an integer of at least 0 and no greater than 5, b5 and b6 each represent, independently of one another, an integer of at least 0 and no greater than 4, and d and e each represent, independently of one another, 0 or 1.

13. The electrophotographic photosensitive member according to claim 1, wherein
the hole transport material includes a compound represented by formula (HTM-1):

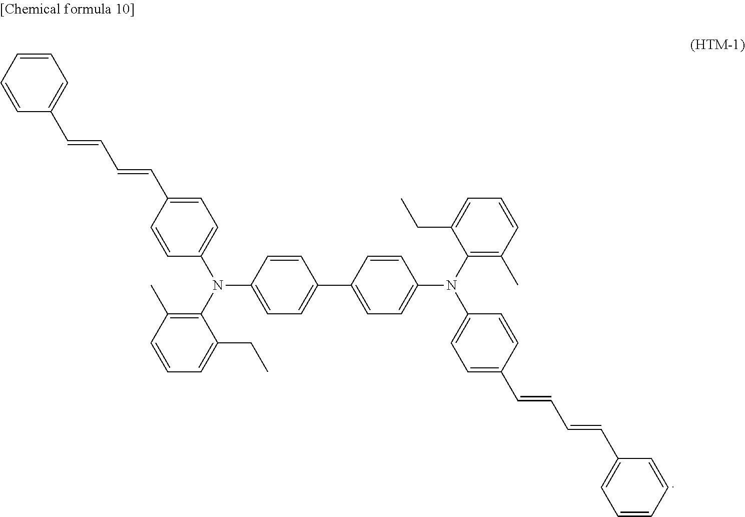 [SMILES: CCc1cccc(C)c1N(c1ccc(/C=C/C=C/c2ccccc2)cc1)c1ccc(-c2ccc(N(c3ccc(/C=C/C=C/c4ccccc4)cc3)c3c(C)cccc3CC)cc2)cc1]

14. The electrophotographic photosensitive member according to claim 1, wherein
the photosensitive layer includes a charge generating layer and a charge transport layer,
the charge generating layer contains the charge generating material,
the charge transport layer contains the hole transport material, the first resin, and the second resin, and
the charge transport layer is provided as an outermost surface layer.
